(19) United States
(12) Patent Application Publication
(10) Pub. No.: US 2003/0225863 A1
(43) Pub. Date: Dec. 4, 2003

(54) Data distribution system

(76) Inventors: Osamu Kajino, Kadoma (JP); Yoshihiro Mushika, Neyagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/452,643

(22) Filed: Jun. 3, 2003

(30) Foreign Application Priority Data
Jun. 4, 2002 (JP) 2002-163076

(51) Int. Cl. G06F 15/16

(52) U.S. Cl. 709/219

(57) ABSTRACT

There is provided a data distribution system which prevents unauthorized copying while permitting copying for private use. To a server 100, a home server 200 transmits identification data identifying a user and/or a device with respect to which/whom playback permission of copyrighted-material data is requested, and requests transmission of a desired piece of copyrighted-material data. The server 100 transmits the copyrighted-material data to a home server 200, with the identification data being appended to the desired piece of copyrighted-material data. The home server 200 receives the copyrighted-material data from the server 100. Based on the identification data appended to the copyrighted-material data, the home server 200 determines whether or not playback is permitted with respect to a user and/or a device that is attempting to play back copyrighted-material data, and plays the back copyrighted-material data if playback is permitted.

### BACKGROUND OF THE INVENTION

1. Field of the Invention

The present invention relates to a system for distributing encoded data of copyrighted materials, and more particularly to a system for implementing copyright protection.

2. Description of the Background Art

With the prevalence of broadband environments for the Internet, the recent years have seen a rapid advancement in systems for allowing encoded data of copyrighted materials (e.g., music movies, or novels), stored in a server, to be downloaded via communication devices such as PCs (personal computers) or mobile phones. In the present specification, such systems are referred to as “data distribution systems”, and any digital data of copyrighted material stored in a server is referred to as “copyrighted-material data”. In data distribution systems, there is an essential issue of how to prevent unauthorized copying in order to ensure copyright protection. Hence, various techniques for preventing unauthorized copying have been proposed.

Examples of systems for preventing unauthorized copying are disclosed at http://www.labelgate.com/help/faq_general.html (an Internet document published by Label Gate Co., Ltd., available as of Apr. 24, 2002) and at http://www.logitec.co.jp/etc/m_id/m_id.html (an Internet document published by Logitec Corp., available as of Apr. 24, 2002). Hereinafter, the conventional systems disclosed at these URLs will be referred to as “machine-dependent exclusive playback systems”.

FIG. 33 is a diagram illustrating the functions of a conventional machine-dependent exclusive playback system. In this conventional machine-dependent exclusive playback system, where copyrighted-material data is downloaded by a PC (Personal Computer) 3001, the copyrighted-material data cannot be played back any other PC such as a PC 3002. As used herein, a playback of copyrighted-material data means reproduction of the copyrighted material, such as playing a piece of music, showing a movie, or displaying a novel, for example.

In the conventional machine-dependent exclusive playback system, copyrighted-material data can only be played back on a PC which has downloaded it, leading to the dissatisfaction of users who own more than one PC. Therefore, several manufacturers of MO drives and/or MO media have launched a general standard called “media ID”, in which they proposed a system where copyrighted-material data can be played back on a PC other than the PC which has downloaded the copyrighted-material data.

Conventional systems for preventing unauthorized copying by utilizing media IDs are disclosed in the aforementioned Internet document published by Logitec Corp., and also in Ryoichi SASAKI, “CIDF document TG establishment meeting”, Jan. 19, 2001, (a document published by Hitachi, Ltd., Systems Development Laboratory, available at http://www.cidf.org/japanese/information/docs/cidf-iftxt-1.pd f as of Apr. 23, 2002). Hereinafter, such systems will be referred to as “media ID-based systems”.

FIG. 34 is a diagram illustrating the functions of a conventional media ID-based system. In accordance with this conventional media ID-based system, MOs (Magneto-Optical disks) are produced so as to contain different media IDs. When a PC 3003 which has downloaded copyrighted-material data stores the copyrighted-material data for the first time on an MO 3004, the PC 3003 stores the copyrighted-material data in association with the media ID of the MO 3004. As such, the media ID of the MO 3004 is referred to as the “media ID at the time of copying” (assuming that the MO 3004 is the first to store the downloaded copyrighted-material data).

When playing back the copyrighted-material data stored on the MO 3004, the PC 3003 or another PC 3005 determines whether its associated “media ID at the time of copying” matches the media ID of the MO 3004 or not. The PC 3003 or any other PC 3005 is allowed to play back the copyrighted-material data only when the two media IDs match.

When the copyrighted-material data stored in the MO 3004 is moved or copied to another MO, the associated media ID at the time of copying is also moved or copied to the other MO. Even if one attempts on the PC 3003 or any other PC 3005 to play back this other MO to which the copyrighted-material data has been moved or copied, the PC 3003 or any other PC 3005 cannot play back the copyrighted-material data because the media ID at the time of copying does not match the media ID of the other MO. Thus, in this conventional media ID-based system, playback of copyrighted-material data on a PC other than the PC which has downloaded the copyrighted-material data is permitted, while prohibiting copying or moving of the copyrighted-material data to any MO other than the MO which was the first to store the downloaded copyrighted-material data.

Since MO are not the only media which can record copyrighted-material data, techniques for preventing unauthorized copying on media other than MOs are also necessary. In a system which utilizes license keys (hereinafter such system will be referred to as a “license key-based system”) which is employed in a music distribution service named “Ketai de Music”, the media for storing copyrighted-material data are not limited to MOs.

Systems for preventing unauthorized copying by utilizing license keys are disclosed in the aforementioned document published by Hitachi, Ltd., Systems Development Laboratory, and also in T. HATAYAMA et al., “Superdistribution and the Security of Music Content”, Zasshi Fujitsu, September 2001 (a document published at http://magazine.fujitsu.com/vol52-5/paper16.pdf, available as of Apr. 23, 2002).

FIG. 35 is a diagram illustrating the functions of a conventional license key-based system. In this conventional license key-based system, encrypted copyrighted-material data and a license key for decrypting the data are downloaded by using a mobile phone 3006. The mobile phone 3006 causes the encrypted copyrighted-material data and the license key to be stored to a memory card 3007. By using the license key, the mobile phone 3006 decrypts the encrypted copyrighted-material data to play back the copyrighted-material data.

When playing back the copyrighted-material data on the PC 3008, the user inserts the memory card 3007 in a drive of the PC 3008. The PC 3008 reads the license key stored in the memory card 3007, and decrypts the encrypted copyrighted-material data with the license key, thereby playing back the copyrighted-material data.

The license key-based system is arranged so that the license key is deleted from the recording medium once the license key is copied. Therefore, once the encrypted copyrighted-material data and the license key are copied onto the hard disk of the PC 3008, the license key which has been stored in the memory card 3007 is deleted. In other words, only one copy of the license key can exist. Thus, a license key-based system permits playback of copyrighted-material data on more than one device and moving of the copyrighted-material data to another device, while prohibiting replication of playable copies of the copyrighted-material data onto more than one device.

Thus, any of the above-described conventional system realizes prevention of unauthorized copying by imposing a universal prohibition of copying of copyrighted-material data. As a result, copying of copyrighted-material data onto another device of one's own possession (e.g., a PC, a stereo set, a portable audio player) has even been prohibited. However, the user may wish to play back copyrighted-material data on more than one device, such as a PC or a portable audio player, depending on the situation. Therefore, it is very inconvenient that the user cannot copy copyrighted-material data onto devices of his/her own possession.

Copying of copyrighted material for private purposes is deemed legal by the copyright law (see, for example, Japanese Copyright Law, section 30). Therefore, there is a desire for an ability to at least copy copyrighted material onto devices of one's own possession. It is expected that such a desire will be enhanced as digital appliances undergo further development in the future, such that a number of appliances become capable of exchanging data with one another.

### SUMMARY OF THE INVENTION

Therefore, an object of the present invention is to provide a data distribution system which permits copying of materials for private use while preventing unauthorized copying thereof.

The present invention has the following features to attain the object mentioned above.

A first aspect of the present invention is directed to a data distribution system comprising a server and a communication device, the server storing copyrighted-material data obtained by encoding a copyrighted material, such that the server distributes the copyrighted-material data to the communication device over a network in response to a request from the communication device, wherein, the communication device comprises: permitting condition designation means for allowing a user to designate a permitting condition based on which to permit use of the copyrighted-material data; and copyrighted-material data requesting means for notifying to the server the permitting condition designated via the permitting condition designation means, and requesting transmission of a desired piece of copyrighted-material data, and the server comprises: copyrighted-material data acquisition means for acquiring the desired piece of copyrighted-material data in accordance with the request from the copyrighted-material data requesting means; and copyrighted-material data transmission means for transmitting to the communication device the copyrighted-material data acquired by the copyrighted-material data acquisition means, such that permitting condition data based on the permitting condition notified from the communication device is appended to the transmitted copyrighted-material data, wherein the communication device further comprises: copyrighted-material data reception means for receiving the copyrighted-material data transmitted from the copyrighted-material data transmission means with the appended permitting condition data; and copyrighted-material data transfer means for transferring the copyrighted-material data received by the copyrighted-material data reception means to an external device, with the permitting condition data appended to the transferred copyrighted-material data, wherein the permitting condition data appended to the copyrighted-material data is used to determine whether or not to permit playback of the copyrighted-material data.

Thus, according to the first aspect, copyrighted-material data is transferred with an appended permitting condition, based on which to permit use of the copyrighted-material data, and permission to use the copyrighted-material data is determined based on the permitting condition data. Accordingly, the copyrighted-material data can be freely used within the bounds defined by the permitting condition data. Thus, there is provided a system which prevents unauthorized use while permitting private use.

Preferably, the copyrighted-material data requesting means transmits the permitting condition data to the server when requesting transmission of the copyrighted-material data, and the copyrighted-material data transmission means appends the permitting condition data received from the communication device to the transmitted copyrighted-material data.

Thus, the permitting condition data is sent from the communication device together with a request for transmission of copyrighted-material data. As a result, the server only needs to return the copyrighted-material data by appending the permitting condition data thereto.

For example, the data distribution system further comprises a reproduction device for receiving the copyrighted-material data transferred from the copyrighted-material data transfer means in an on-line or off-line manner and playing back the copyrighted-material data, the reproduction device comprising: playback permission determination means for determining whether or not playback of the copyrighted-material data is permitted based on the permitting condition data appended to the copyrighted-material data; and copyrighted-material data playback means for playing back the copyrighted-material data if the playback permission determination means determines that playback thereof is permitted, wherein, the permitting condition designation means allows the user to designate an individual and/or a reproduction device with respect to whom/which playback permission is requested, the permitting condition data transmitted from the copyrighted-material data requesting means to the server contains identification data identifying the individual and/or reproduction device designated via the permitting condition designation means, and the playback permission determination means determines whether or not playback is permitted with respect to the reproduction device and/or the user operating the reproduction device, by referring to the identification data contained in the permitting condition data.

In this case, it is possible to allow the user to designate an individual and/or a reproduction device with respect to whom/which playback permission is requested, such that the copyrighted-material data can be played back within the bounds of the user's designation. Thus, there is provided a system in which copyrighted-material data can be copied and still played back within the bounds of private use, but cannot be played back for non-private use.

Preferably, the permitting condition data appended to the copyrighted-material data transmitted from the copyrighted-material data transmission means is preregistered at the server with respect to each of a plurality of users.

Thus, the server appends preregistered permitting condition data to the copyrighted-material data. This makes it unnecessary for the user to transmit permitting condition data by means of the communication device every time the user requests copyrighted-material data, thereby facilitating the operation of the system.

Preferably, the data distribution system further comprises a reproduction device for receiving the copyrighted-material data transferred from the copyrighted-material data transfer means in an on-line or off-line manner and playing back the copyrighted-material data, the reproduction device comprising: playback permission determination means for determining whether or not playback of the copyrighted-material data is permitted based on the permitting condition data appended to the copyrighted-material data; and copyrighted-material data playback means for playing back the copyrighted-material data if the playback permission determination means determines that playback thereof is permitted.

Thus, based on the permitting condition data, the reproduction devices determines whether or not playback of the copyrighted-material data is permitted, and plays back the copyrighted-material data only if playback is permitted. As a result, copyrighted-material data can be copied and still played back within the bounds of the permitting condition.

More preferably, the reproduction device further comprises permitting condition deletion means for deleting the permitting condition data appended to the copyrighted-material data received by the reproduction device if the playback permission determination means determines that playback of the copyrighted-material data is not permitted, and the playback permission determination means determines that that playback of the copyrighted-material data is not permitted if the copyrighted-material data does not have the permitting condition data appended thereto.

Thus, if it is determined that playback of the copyrighted-material data is not permitted, i.e., if an unauthorized attempt to play back copyrighted-material data is made, the permitting condition data is deleted so that the copyrighted-material data can no longer be played back. Accordingly, there is provided a system which prohibits the playback of the copyrighted-material data after an unauthorized attempt to play back is made.

More preferably, the copyrighted-material data transmission means further appends, to the copyrighted-material data transmitted to the communication device, an exempting condition based on which to exempt the reproduction device from making a determination as to whether or not to permit playback, the copyrighted-material data transfer means appends the exempting condition to the copyrighted-material data when transferring the copyrighted-material data to the external device, and the playback permission determination means determines that playback of the copyrighted-material data is permitted if the exempting condition appended to the copyrighted-material data is satisfied.

Thus, the copyrighted-material data can be played back also while the exempting condition is satisfied. As a result, an authentication process can be omitted within the bounds of the exempting condition as defined by the provider of the copyrighted-material data, thereby reducing the cumbersomeness associated with authentication.

More preferably, the communication device is capable of communicating with the reproduction device, the communication device further comprises reconfirmation requesting means for requesting, when the playback permission determination means determines that playback of the copyrighted-material data is not permitted, the server to again confirm whether or not playback of the copyrighted-material data is permitted with respect to a user attempting to play back the copyrighted-material data, and the server further comprises: group member determination means for determining, in response to the request from the communication device, whether the user attempting to play back the copyrighted-material data belongs to a group with respect to which playback of the copyrighted-material data is permitted; and playback permission notification means for notifying to the communication device, when the group member determination means determines that the user attempting to play back the copyrighted-material data belongs to the group, that playback of the copyrighted-material data is permitted with respect to the user, the communication device further comprises: result notification means for notifying the notification from the server to the reproduction device, and the playback permission determination means again determines whether or not playback of the copyrighted-material data is permitted based on the notification from the communication device.

Thus, playback is permitted with respect to any user belonging to a group with respect to which playback of the copyrighted-material data is permitted. As a result, copyrighted-material data which has been copied for intra-family or intra-group use, etc., can be played back within the bounds of the designated permission.

More preferably, the reproduction device is capable of communicating with the communication device, the reproduction device further comprises location information detection means for detecting location information, the communication device further comprises authentication location identifying information transmission means for transmitting, when the playback permission determination means determines that playback of the copyrighted-material data is permitted, authentication location identifying information identifying an authentication location to the server, the authentication location identifying information being based on the location information detected by the location information detection means, and the server further comprises: authentication location identifying information reception means for receiving authentication location identifying information from the communication device; authentication location identifying information storage means for storing the authentication location identifying information received by the authentication location identifying information reception means; and dishonest authentication determination means for recognizing a hypothetical movement of a user based on the authentication location identifying information already stored in the authentication location identifying information storage means, and detecting, based on the hypothetical movement, an unauthorized attempt to use the copyrighted-material data by a person who is in disguise of an authorized user.

Thus, based on a hypothetical movement of a user, any unauthorized attempt to use the copyrighted-material data by a person who is in disguise of an authorized user can be detected. As a result, voluntary refrainment from unauthorized copying of copyrighted-material data over a network can be expected.

More preferably, the permitting condition designation means allows the user to designate an individual and/or a reproduction device with respect to whom/which playback permission is requested, the permitting condition data contains identification data identifying the individual and/or reproduction device designated via the permitting condition designation means, and the playback permission determination means determines whether or not playback is permitted with respect to the reproduction device and/or the user operating the reproduction device, by referring to the identification data contained in the permitting condition data.

Thus, it possible to allow a user to designate an individual and/or a reproduction device with respect to whom/which playback permission is requested, such that the copyrighted-material data can be played back within the bounds of the user's designation. Thus, there is provided a system in which copyrighted-material data can be copied and still played back within the bounds of private use, but cannot be played back for non-private use.

Preferably, the copyrighted-material data transmission means appends the permitting condition data as an inseparable electronic watermark in the copyrighted-material data.

Thus, the permitting condition data is embedded in the form of an electronic watermark in the copyrighted-material data, thereby making it impossible to extract only the copyrighted-material data. When the copyrighted-material data is replicated through unauthorized copying, the permitting condition data is also copied, based on which unauthorized copying can be determined. As a result, voluntary refrainment from unauthorized copying can be expected.

Preferably, the copyrighted-material data transmission means appends the permitting condition data to the copyrighted-material data in an inseparable manner.

Thus, the permitting condition data is appended to the copyrighted-material data in an inseparable manner, thereby making it impossible to extract only the copyrighted-material data so as to use it for unauthorized purposes.

For example, the copyrighted-material data transmission means appends the permitting condition data to the copyrighted-material data in a separable manner, but encrypts the copyrighted-material data together with the appended permitting condition data so that the permitting condition data becomes inseparable from the transmitted copyrighted-material data, and the copyrighted-material data transfer means transfers the encrypted copyrighted-material data with appended permitting condition data.

In this case, the copyrighted-material data is transferred in an encrypted form, thereby making it impossible to extract only the decrypted copyrighted-material data and copy it for unauthorized purposes.

Preferably, the data distribution system further comprises a device on which the copyrighted-material data transferred from the copyrighted-material data transfer means is to be used, wherein the device comprises use permission determination means for determining whether or not playback of the copyrighted-material data is permitted based on the permitting condition data appended to the copyrighted-material data.

Thus, permission to use the copyrighted-material data is determined based on the permitting condition data appended to the copyrighted-material data. As a result, it is possible to permit the use of the copyrighted-material data within the bounds of private use while preventing its use for non-private use.

A second aspect of the present invention is directed to a server storing copyrighted-material data obtained by encoding a copyrighted material, and distributing the copyrighted-material data to a communication device which is connected to the server over a network in response to a request from the communication device, the server comprising: copyrighted-material data acquisition means for acquiring a desired piece of copyrighted-material data in accordance with the request from the communication device; and copyrighted-material data transmission means for transmitting to the communication device the copyrighted-material data acquired by the copyrighted-material data acquisition means, such that permitting condition data based on which to permit use of the copyrighted-material data is appended to the transmitted copyrighted-material data.

Thus, according to the second aspect, copyrighted-material data having a permitting condition appended thereto is transmitted, in accordance with a request from the communication device. As a result, there is provided a server for distributing copyrighted-material data which permits private use of the copyrighted-material data.

For example, the permitting condition data is data which is transmitted from the communication device together with the request to transmit copyrighted-material data.

In this case, the server only needs to return the copyrighted-material data by appending thereto the permitting condition data which is sent from the communication device together with the request for transmission of copyrighted-material data.

For example, the permitting condition data is preregistered at the server with respect to each of a plurality of users.

In this case, the server appends preregistered permitting condition data to the copyrighted-material data.

Preferably, the server further comprises playback permission notification means for, in response to a request from the communication device, determining whether or not playback of the copyrighted-material data is permitted with respect to a user attempting to play back the copyrighted-material data, and notifying to the communication device a result of the determination.

Thus, playback permission is determined with respect to a user attempting to play back copyrighted-material data. As a result, any piece of copyrighted-material data which has been copied for private use can be permitted to be played back.

For example, the playback permission notification means determines that playback of the copyrighted-material data is permitted with respect to the user attempting to play back the copyrighted-material data if the user belongs to a group with respect to which playback of the copyrighted-material data is permitted.

In this case, playback is permitted with respect to any member belonging to a group with respect to which playback of the copyrighted-material data is permitted. As a result, copyrighted-material data which has been copied for intra-family or intra-group use, etc., can be played back.

Preferably, the copyrighted-material data transmission means further appends, to the copyrighted-material data transmitted to the communication device, an exempting condition based on which to exempt a reproduction device from making a determination as to whether or not to permit playback of the copyrighted-material data.

Thus, the provider of the copyrighted-material data can designate an exempting condition based on which to omit the determination as to whether or not playback is permitted. As a result, it becomes possible to adjust the frequency with which to perform authentications for playing back copyrighted-material data.

Preferably, the server further comprises: authentication location identifying information reception means for receiving from the communication device authentication location identifying information which identifies an authentication location of the copyrighted-material data; authentication location identifying information storage means for storing the authentication location identifying information received by the authentication location identifying information reception means; and dishonest authentication determination means for recognizing a hypothetical movement of a user based on the authentication location identifying information already stored in the authentication location identifying information storage means, and detecting, based on the hypothetical movement, an unauthorized attempt to use the copyrighted-material data by a person who is in disguise of an authorized user.

A third aspect of the present invention is directed to a communication device being connected via a network to a server storing copyrighted-material data obtained by encoding a copyrighted material, and downloading the copyrighted-material data from the server, comprising: permitting condition-designation means for allowing a user to designate a permitting condition based on which to permit use of the copyrighted-material data; copyrighted-material data requesting means for notifying to the server the permitting condition designated via the permitting condition designation means, and requesting transmission of a desired piece of copyrighted-material data, copyrighted-material data reception means for receiving the copyrighted-material data transmitted from the server, with permitting condition data based on the permitting condition notified being appended to the transmitted copyrighted-material data; and copyrighted-material data transfer means for transferring the copyrighted-material data received by the copyrighted-material data reception means to an external device, with the permitting condition data appended to the transferred copyrighted-material data.

Thus, according to the third aspect, a user is allowed to designate a permitting condition, and will receive copyrighted-material data having that permitting condition appended thereto. As a result, the user is allowed to download copyrighted-material data which permits private use. Since the copyrighted-material data is transferred with the permitting condition appended thereto, the copyrighted-material data can be copied and still played back within the bounds of the permitting condition.

For example, the permitting condition data is data which is transmitted to the server together with a request to transmit copyrighted-material data.

For example, the permitting condition designation means allows the user to designate an individual and/or a reproduction device with respect to whom/which playback permission is requested, the permitting condition data transmitted from the copyrighted-material data requesting means to the server when making the request to transmit copyrighted-material data contains identification data identifying the individual and/or reproduction device designated via the permitting condition designation means.

In this case, an individual and/or a reproduction device with respect to whom/which playback permission is requested can be designated. As a result, the copyrighted-material data can be played back or copied on a reproduction device possessed by the user, or played back by the user himself/herself.

For example, the identification data is biological information identifying the individual.

Thus, the communication device uses biological information for identifying an individual, thereby providing a better prevention of unauthorized use than in the case of using a password.

For example, the permitting condition data is preregistered at the server with respect to each of a plurality of users.

A fourth aspect of the present invention is directed to a reproduction device for playing back copyrighted-material data obtained by encoding a copyrighted material, wherein a permitting condition based on which to permit use of the copyrighted-material data is appended to the copyrighted-material data, the reproduction device comprising: playback permission determination means for determining whether or not playback of the copyrighted-material data is permitted based on the permitting condition data appended to the copyrighted-material data; and copyrighted-material data playback means for playing back the copyrighted-material data if the playback permission determination means determines that playback thereof is permitted.

Thus, according to the fourth aspect, copyrighted-material data can be played back so long as the playback thereof is permitted based on the permitting condition data. Accordingly, the copyrighted-material data can be copied and still freely played back within the bounds defined by the permitting condition.

Preferably, the reproduction device further comprises individual identification information acquisition means for acquiring identification information concerning a user attempting to playback the copyrighted-material data, wherein, the permitting condition data appended to the copyrighted-material data contains identification information concerning an individual with respect to whom playback of the copyrighted-material data is permitted, and the playback permission determination means determines that playback of the copyrighted-material data is permitted if the identification information acquired by the individual identification information acquisition means matches the identification information contained in the permitting condition data.

Thus, the copyrighted-material data can be played back by a user with respect to whom playback is permitted. As a result, the copyrighted-material data can be copied and still freely played back within the bounds defined by the permitting condition.

More preferably, authentication exempted period information defining an authentication exempted period during which determination as to whether or not to permit playback of the copyrighted-material data is exempted is further appended to the copyrighted-material data, and during the authentication exempted period, the playback permission determination means omits determination as to whether the identification information acquired by the individual identification information acquisition means matches the identification information contained in the permitting condition data or not.

Thus, individual authentication is omitted during the authentication exempted period, thereby reducing the cumbersomeness associated with authentication.

For example, if the authentication exempted period is predicted to expire during the playback of the copyrighted-material data, the playback permission determination means presents a warning message prior to the expiration of the authentication exempted period, and determines whether or not playback of the copyrighted-material data is permitted by determining whether the identification information acquired by the individual identification information acquisition means matches the identification information contained in the permitting condition data or not.

In this case, a warning message is given prior to the expiration of the authentication exempted period, followed by an actual authentication process. As a result, the playback of the copyrighted-material data can be prevented from being interrupted because of the authentication exempted period coming to expiration during the playback of the copyrighted-material data.

More preferably, a plurality of pieces of copyrighted-material data are to be consecutively played back, and if the authentication exempted period is predicted to expire during the playback of one of the plurality of pieces of copyrighted-material data to be consecutively played back, the playback permission determination means makes a prior determination, with respect to the piece of copyrighted-material data, as to whether the identification information acquired by the individual identification information acquisition means matches the identification information contained in the permitting condition data or not.

Thus, a prior authentication process is performed with respect to a plurality of pieces of copyrighted-material data to be consecutively played back. As a result, it is unnecessary to perform cumbersome authentication processes during a consecutive playback of the copyrighted-material data.

For example, if the authentication exempted period is predicted to expire during the playback of the copyrighted-material data, the playback permission determination means presents a warning message prior to the expiration of the authentication exempted period, and determines whether or not playback of the copyrighted-material data is permitted by determining whether the identification information acquired by the individual identification information acquisition means matches the identification information contained in the permitting condition data or not.

In this case, a warning message is given prior to the expiration of the authentication exempted period, followed by an actual authentication process. As a result, the playback of the copyrighted-material data can be prevented from being interrupted because of the authentication exempted period coming to expiration during the playback of the copyrighted-material data.

For example, the identification information is biological information concerning an individual with respect whom playback of the copyrighted-material data is permitted, and the individual identification information acquisition means is a biological information detection sensor.

In this case, each individual is identified based on biological information. Thus, an improved operational environment for authentication can be provided.

For example, the biological information is fingerprint data of the user, and the biological information detection sensor is a fingerprint sensor.

In this case, each individual is identified by means of a fingerprint sensor, such that the user only needs to present a finger to the fingerprint sensor. Thus, an improved operational environment for authentication can be provided.

For example, the reproduction device further comprises device identification information storage means for storing device identification information which is uniquely assigned to the reproduction device, wherein, the permitting condition data appended to the copyrighted-material data contains device identification information concerning a reproduction device with respect to which playback of the copyrighted-material data is permitted, and the playback permission determination means determines that playback of the copyrighted-material data is permitted if the device identification information stored in the device identification information storage means matches the device identification information contained in the permitting condition data.

In this case, copyrighted-material data can be played back on a reproduction device with respect to which playback of the copyrighted-material data is permitted. As a result, the copyrighted-material data can be copied and still freely played back on a reproduction device or the like possessed by the user.

Preferably, the reproduction device further comprises: communication means for communicating with a communication device which is connected via a network to a server storing the copyrighted-material data and downloads the copyrighted-material data from the server; and reconfirmation requesting means for, if the playback permission determination means determines that playback of the copyrighted-material data is not permitted, requesting the server via the communication means to reconfirm whether or not playback of the copyrighted-material data is permitted with respect to a user attempting to play back the copyrighted-material data, wherein the playback permission determination means again determines whether or not playback of the copyrighted-material data is permitted based on a result of the reconfirmation which is notified from the server in response to the request from the reconfirmation requesting means.

Thus, if the server reconfirms that playback of the copyrighted-material data is permitted, the copyrighted-material data can be played back. As a result, the copyrighted-material data can be copied and still played back so long as it has permission from the server.

Preferably, the reproduction device further comprises: communication means for communicating with a communication device which is connected via a network to a server storing the copyrighted-material data and downloads the copyrighted-material data from the server; location information detection means for detecting location information; and authentication location identifying information transmission means for, when the playback permission determination means determines that playback of the copyrighted-material data is permitted, transmitting authentication location identifying information identifying an authentication location to the server via the communication means, the authentication location identifying information being based on the location information detected by the location information detection means, wherein the authentication location identifying information is used for detecting an unauthorized attempt at the server to use the copyrighted-material data by a person who is in disguise of an authorized user.

Preferably, the reproduction device further comprises permitting condition deletion means for deleting the permitting condition data appended to the copyrighted-material data if the playback permission determination means determines that playback of the copyrighted-material data is not permitted, wherein the playback permission determination means determines that that playback of the copyrighted-material data is not permitted if the copyrighted-material data does not have the permitting condition data appended thereto.

A fifth aspect of the present invention is directed to an authentication system comprising a server and a communication device which are interconnected over a network for performing an authentication therebetween, wherein, the communication device comprises: location information detection means for detecting location information; and authentication location identifying information transmission means for transmitting, when performing an authentication for the server, authentication location identifying information identifying an authentication location to the server, the authentication location identifying information being based on the location information detected by the location information detection means, and the server comprises: authentication location identifying information reception means for receiving authentication location identifying information from the communication device; authentication location identifying information storage means for storing the authentication location identifying information received by the authentication location identifying information reception means; and dishonest authentication determination means for recognizing a hypothetical movement of a user based on the authentication location identifying information already stored in the authentication location identifying information storage means, and detecting, based on the hypothetical movement, an unauthorized attempt to use the copyrighted-material data by a person who is in disguise of an authorized user.

Thus, according to the fifth aspect, any authentication attempt by a person who is in disguise of an authorized user can be detected based on a hypothetical movement of the user. As a result, dishonest authentication can be prevented.

A sixth aspect of the present invention is directed to a method of controlling a system comprising a server storing copyrighted-material data obtained by encoding a copyrighted material, a communication device, and a reproduction device, such that, in response to a request from the communication device, the server distributes the copyrighted-material data to the communication device over a network so as to be played back by the reproduction device, comprising: a step, performed by the communication device, of allowing a user to designate a permitting condition based on which to permit use of the copyrighted-material data; a step, performed by the communication device, of notifying the permitting condition to the server, and requesting transmission of a desired piece of copyrighted-material data; a step, performed by the server of acquiring the desired piece of copyrighted-material data in accordance with the request from the communication device; a step, performed by the server of transmitting to the communication device the acquired copyrighted-material data, such that permitting condition data based on the permitting condition notified from the communication device is appended to the transmitted copyrighted-material data; a step, performed by the communication device, of receiving the copyrighted-material data transmitted from the server with the appended permitting condition data; a step, performed by the communication device, of transferring the received copyrighted-material data to the reproduction device, with the permitting condition data appended to the transferred copyrighted-material data; a step, performed by the reproduction device, of determining whether or not to permit playback of the copyrighted-material data based on the permitting condition data appended to the copyrighted-material data; and a step, performed by the reproduction device, of playing back the copyrighted-material data if it is determined that the playback of the copyrighted-material data is permitted.

Thus, according to the sixth aspect, a user is allowed to designate a condition based on which to permit use of copyrighted-material data, such that the copyrighted-material data can be played back on a reproduction device within the bounds of the designated condition. As a result, there is provided a method for preventing unauthorized copying while permitting copying for private use.

For example, the permitting condition data is data which is transmitted from the communication device together with the request to transmit copyrighted-material data.

For example, the permitting condition data is preregistered at the server with respect to each of a plurality of users.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating an overall structure of a data distribution system according to a first embodiment of the present invention;

FIG. 2 is a diagram illustrating the structure of copyrighted material request data;

FIG. 3 is a diagram illustrating the structure of copyrighted material reply data;

FIG. 4 is a diagram illustrating the structure of inter-terminal data;

FIG. 5 is a block diagram illustrating the structure of a server 100 according to the first embodiment of the present invention;

FIG. 6 is a diagram illustrating an example of personal information stored in a personal data storage section 102;

FIG. 7 is a diagram illustrating an example of data stored in a copyrighted-material data storage section 103;

FIG. 8 is a block diagram illustrating the structure of a home server 200 according to the first embodiment of the present invention;

FIG. 9 is a diagram illustrating an example of data stored in a fingerprint data storage section 207;

FIG. 10 is a diagram illustrating an example of data stored in a device ID storage section 208;

FIG. 11 is a diagram illustrating an example of data stored in a copyrighted-material data storage section 203;

FIG. 12 is a diagram illustrating an exemplary image displayed on a display screen of a display/playback unit 206 when requesting transmission of copyrighted-material data;

FIG. 13 is a block diagram illustrating the structure of an external reproduction device 300 according to the first embodiment of the present invention;

FIG. 14 is a diagram illustrating an example of data stored in a copyrighted-material data storage section 303;

FIG. 15 is a flowchart illustrating a data request process performed by a data request control section 241 of a communication device 240 according to the first embodiment of the present invention;

FIG. 16 is a flowchart illustrating a copy process performed by the data request control section 241 according to the first embodiment of the present invention;

FIG. 17 is a flowchart illustrating a data playback process performed by a playback control section 231 according to the first embodiment of the present invention;

FIG. 18 is a flowchart illustrating a device ID registration process performed by a control section 301 of an external reproduction device 300 according to the first embodiment of the present invention;

FIG. 19 is a flowchart illustrating a device-side data playback process performed by the control section 301 of the external reproduction device 300 according to the first embodiment of the present invention;

FIG. 20 is a diagram illustrating the structure of copyrighted material reply data according to a second embodiment of the present invention;

FIG. 21 is a diagram illustrating the structure of inter-terminal data according to the second embodiment of the present invention;

FIG. 22 is a diagram illustrating an example of data stored in an authentication history storage section;

FIG. 23 is a flowchart illustrating an operation of an internal reproduction device 230 or the external reproduction device 300 according to the second embodiment of the present invention when playing back copyrighted-material data;

FIG. 24 is a flowchart illustrating an operation of the internal reproduction device 230 or the external reproduction device 300 according to the second embodiment of the present invention when playing back a plurality of copyrighted-material data having a long playback time;

FIG. 25 is a diagram illustrating an example of family data;

FIG. 26 is a diagram illustrating the data structure of copyrighted material reply data according to a third embodiment of the present invention;

FIG. 27 is a diagram illustrating an example of data stored in the copyrighted-material data storage section 203 of the internal reproduction device 230 according to the third embodiment of the present invention;

FIG. 28 is a flowchart illustrating an operation of the internal reproduction device 230 according to the third embodiment of the present invention when playing back copyrighted-material data;

FIG. 29 is a flowchart illustrating an operation of the internal reproduction device 230 in a variant where step S1007 involves deletion of encrypted identification data;

FIG. 30 is a diagram illustrating an example of data stored in a location information history storage section;

FIG. 31 is a flowchart illustrating an operation of the server 100 according to a fourth embodiment of the present invention when receiving authentication location identifying information;

FIG. 32 is a flowchart illustrating operations of the server 100, the communication device 240, and the internal reproduction device 230 according to a fifth embodiment of the present invention;

FIG. 33 is a diagram illustrating the functions of a conventional machine-dependent exclusive playback system;

FIG. 34 is a diagram illustrating the functions of a conventional media ID-based system; and

FIG. 35 is a diagram illustrating the functions of a conventional license key-based system.

### DESCRIPTION OF THE PREFERRED EMBODIMENTS

(First Embodiment)

FIG. 1 is a block diagram illustrating an overall structure of a data distribution system according to a first embodiment of the present invention. In FIG. 1, the data distribution system comprises servers 100, a home server 200, external reproduction devices 300, and a network 400. The home server 200 includes a communication device 240 and an internal reproduction device 230. The numbers of servers 100, home servers 200 and external reproduction devices 300 are not limited to those shown in FIG. 1.

Throughout the present specification, it is assumed that the user is already entitled to purchasing copyrighted-material data, as registered at a server 100. When receiving a request for transmitting copyrighted-material data, the server 100 confirms whether the user is entitled to purchasing the copyrighted-material data or not, and returns copyrighted-material data to the communication device 240 only if the user is determined as an entitled user. The confirmation of entitlement at the server 100 is not an essential portion of the present invention, and the description thereof is therefore omitted.

In the first embodiment, the user utilizes the communication device 240 to request a server 100 to transmit copyrighted-material data. The communication device 240 allows the user to designate at least one entity (among an individual, the internal reproduction device 230, and an external reproduction device 300) with respect to whom/which playback permission is requested. The communication device 240 transmits identification data and an authentication type to the server 100, and requests transmission of copyrighted-material data. As used herein, the “identification data” is data identifying the entity(s) designated by the user. The “authentication type” indicates a manner of authentication (i.e., fingerprint authentication or device authentication; described below) as to whether playback is permitted or not. At the server 100, the authentication type and identification data which have been sent from the communication device 240 are appended to the copyrighted-material data to be transmitted. Then, the server 100 transmits the copyrighted-material data, with the authentication type and identification data appended thereto, to the communication device 240. At the internal reproduction device 230 or the external reproduction device 300, it is determined whether playback of the copyrighted-material data is permitted or not, by performing fingerprint authentication or device authentication based on the authentication type and identification data appended to the received copyrighted-material data. If the playback of the copyrighted-material data is permitted (i.e., if the identification data matches), the copyrighted-material data is played back. That is, the copyrighted-material data will be permitted to be played back only on the designated entity(s).

The network 400 (e.g., the Internet) mediates the communications between the servers 100 and the home server 200. Each server 100 stores copyrighted-material data of music, movies, novels, or the like, and transmits such copyrighted-material data upon receiving a request from the home server 200. The communication device 240 downloads copyrighted-material data from the server(s) 100 via the network 400. The communication device 240 transfers the acquired copyrighted-material data to the internal reproduction device 230 or the external reproduction device(s) 300. The internal reproduction device 230 acquires the copyrighted-material data via on-line communications with the communication device 240, and plays back the copyrighted-material data. Each external reproduction device 300 is a device which plays back the copyrighted-material data, e.g., a stereo set, a portable audio player, a video cassette player, or an electronic book, or the like. Each external reproduction device 300 acquires copyrighted-material data via on-line communications with the communication device 240, and plays back the copyrighted-material data. Alternatively, each external reproduction device 300 may acquire copyrighted-material data in off-line fashion, e.g., via a recording medium such as a memory card. Each of the internal reproduction device 230 and the external reproduction devices 300 functions independently of the communication device 240, and can play back copyrighted-material data on its own.

At the internal reproduction device 230 or an external reproduction device 300, an authentication process must be performed, prior to playing back copyrighted-material data, in order to determine whether playback of the copyrighted-material data is permitted or not. The present embodiment employs one of the following two authentication methods (fingerprint authentication or device authentication).

In a first authentication method (referred to as “fingerprint authentication”), the internal reproduction device 230 or external reproduction device 300 determines whether a given user is permitted to play back the copyrighted-material data or not, based on individual identification information (e.g., fingerprint data obtained by encoding a fingerprint of the user) for identifying the user who wishes to play back the copyrighted-material data.

In a second authentication method (referred to as “device authentication”), the internal reproduction device 230 or external reproduction device 300 determines whether a given device is permitted to play back the copyrighted-material data or not, based on an ID (hereinafter referred to as “device ID”) which is uniquely assigned to any device on which playback of the copyrighted-material data is requested.

The fingerprint data or device ID, which are identification information for identifying an entity (a user or a device) with respect to which playback of copyrighted-material data is permitted, will collectively be referred to as “identification data”.

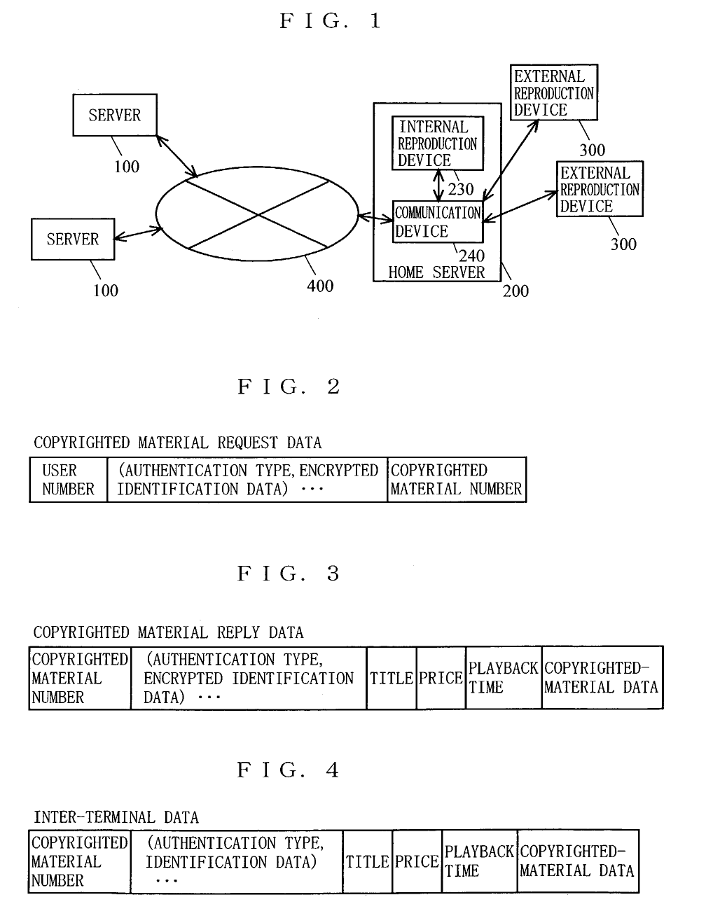

FIG. 2 is a diagram illustrating the structure of data which is transmitted from the communication device 240 to a server 100 when requesting transmission of copyrighted-material data (hereinafter referred to as “copyrighted material request data”). As shown in FIG. 2, the copyrighted material request data contains: a user number; an authentication type(s); encrypted identification data, which is an encrypted version of the identification data identifying an entity with respect to which playback permission of copyrighted-material data has been requested by the user; and a copyrighted material number representing the desired copyrighted-material data. At least one pair of an authentication type and encrypted identification data is contained in the copyrighted material request data. The authentication type and the encrypted identification data, which together represent conditions for entities for which playback permission is requested, will collectively be referred to as “permitting condition data”. In each pair of an authentication type and encrypted identification data, the encrypted identification data is one that has been obtained by encrypting identification data with the authentication method designated by the authentication type. Depending on the manners the user expects to use the copyrighted-material data, the user may designate a plurality of pairs of authentication types and encrypted identification data.

In the case where the authentication type is “fingerprint authentication”, the identification data is the user's fingerprint data. In the case where the authentication type is “device authentication”, the identification data is a device ID which is uniquely assigned to the internal reproduction device 230 or an external reproduction device 300 possessed by the user. The reason why the identification data is encrypted in the copyrighted material request data is in order to prevent foul use of the identification data over the network.

FIG. 3 is a diagram illustrating the structure of data which is transmitted from a server 100 to the communication device 240 (herein after referred to as “copyrighted material reply data”) in response to the copyrighted material request data from the communication device 240. As shown in FIG. 3, the copyrighted material reply data contains: a copyrighted material number; an authentication type(s); encrypted identification data; a title; a price; playback time; and copyrighted-material data.

The copyrighted material reply data contains the same pair(s) of an authentication type(s) and encrypted identification data that are contained in the copyrighted material request data. At least one pair of such an authentication type and encrypted identification data is contained in the copyrighted material reply data. The copyrighted-material data is the data which is obtained by subjecting a copyrighted material (e.g., music, video, a novel) to digital compression/encoding. The “title” represents the title of the copyrighted material. The “price” represents the price at which the copyrighted-material data can be purchased. The “playback time” represents the amount of time required to play back the copyrighted-material data.

FIG. 4 is a diagram illustrating the structure of data (containing copyrighted-material data) which is transmitted from the communication device 240 to an external reproduction device 300 (hereinafter referred to as “inter-terminal data”). As shown in FIG. 4, the inter-terminal data contains: a copyrighted material number; an authentication type(s); identification data; a title; a price; playback time; and copyrighted-material data. The copyrighted material number, the title, the price, the playback time, and the copyrighted-material data are identical to their respective counterparts contained in the copyrighted material reply data. The identification data is a decrypted version of the encrypted identification data contained in the copyrighted material reply data. In the inter-terminal data, too, at least one pair of an authentication type(s) and identification data is contained. The reason why the encrypted identification data has already been decrypted in the inter-terminal data is in order to reduce the processing load of decryption at the external reproduction device 300.

Hereinafter, with reference to FIGS. 1 to 4, the overall process performed in the system, from downloading copyrighted-material data and playing it back, will be briefly described. The communication device 240 prompts a user to designate an individual(s) and/or a device(s) with respect to whom/which playback permission of copyrighted-material data is requested. Based on at least one pair of an authentication type and encrypted identification data and a copyrighted material number, the communication device 240 generates copyrighted material request data, and transmits the generated copyrighted material request data to a server 100 via the network 400. Upon receiving the copyrighted material request data, the server 100 retrieves the permitting condition data (authentication type and encrypted identification data) contained in the copyrighted material request data. The server 100 reads a piece of copyrighted-material data corresponding to the copyrighted material number from a recording medium such as a hard disk. The server 100 generates copyrighted material reply data by appending the received authentication type and the encrypted identification data to the copyrighted-material data, and transmits the generated copyrighted material reply data to the communication device 240. The authentication type and the encrypted identification data remain appended to the copyrighted-material data when it is transferred from the communication device 240 to the internal reproduction device 230. Based on the authentication type and the encrypted identification data appended to the copyrighted-material data, the internal reproduction device 230 determines whether or not playback is permitted with respect to a user and/or a device that is attempting to play back copyrighted-material data, and plays back the copyrighted-material data if playback is permitted.

When transferring the copyrighted-material data to an external reproduction device 300, the communication device 240 decrypts the encrypted identification data, and appends the authentication type and identification data to the copyrighted-material data, thereby generating inter-terminal data. Based on the authentication type and identification data stored in the inter-terminal data, the external reproduction device 300 determines whether or not playback is permitted with respect to a user and/or a device that is attempting to play back the copyrighted-material data, and plays back the copyrighted-material data if playback is permitted. The operations of the respective device in the system will be described in more detail below.

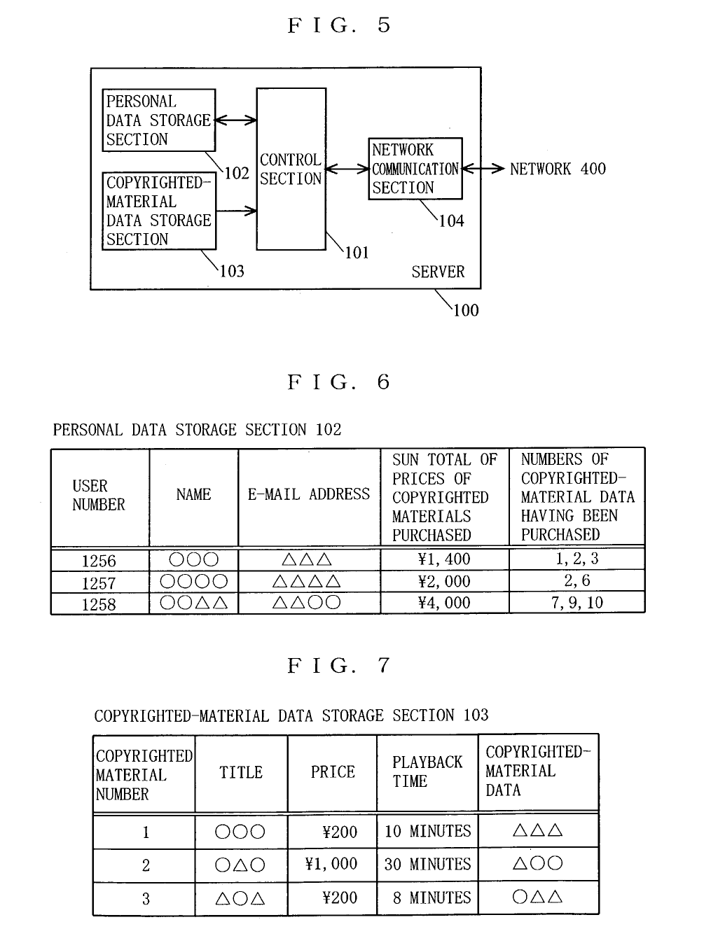

FIG. 5 is a block diagram illustrating the structure of a server 100 according to the first embodiment of the present invention. As shown in FIG. 5, the server 100 includes a control section 101, a personal data storage section 102, a copyrighted-material data storage section 103, and a network communication section 104. The network communication section 104 sends copyrighted material request data from the home server 200 via the network 400 to the control section 101, and transmits copyrighted material reply data from the control section 101 to the home server 200 via the network 400.

The personal data storage section 102, which comprises a recording medium such as a hard disk, stores personal information concerning users who are entitled to the services provided by the data distribution system. FIG. 6 is a diagram illustrating an example of personal information stored in the personal data storage section 102. The personal data storage section 102 stores, in association with each user number, the name of the user, an e-mail address of the user, a sum total of prices of the copyrighted materials purchased by the user, and the numbers of the copyrighted-material data which have been purchased.

The copyrighted-material data storage section 103, which comprises a recording medium such as a hard disk, stores copyrighted-material data and their associated information. FIG. 7 is a diagram illustrating an example of data stored in the copyrighted-material data storage section 103. The copyrighted-material data storage section 103 stores, in association with each copyrighted material number, the title of the copyrighted material, the price of the copyrighted material, the playback time of the copyrighted-material data, and the copyrighted-material data itself. The personal data storage section 102 and the copyrighted-material data storage section 103 may be implemented within a single hard disk.

Via the network communication section 104, the control section 101 receives the copyrighted material request data sent from the home server 200. The control section 101 extracts the authentication type(s) and the encrypted identification data contained in the copyrighted material request data. The control section 101 reads from the copyrighted-material data storage section 103 a piece of copyrighted-material data and its associated information (the title, price and playback time) corresponding to a copyrighted material number contained in the copyrighted material request data. Based on the permitting condition data (the authentication type and encrypted identification data) and the copyrighted-material data and its associated information (the title, price, and playback time), the control section 101 generates copyrighted material reply data, and transmits the generated copyrighted-material data to the requesting home server 200. Having transmitted the copyrighted material reply data, the control section 101 updates the relevant sum total of prices of the purchased copyrighted materials as stored in the personal data storage section 102. If a request to register a user has been made from the home server 200, the control section 101 registers the personal information concerning the user to be registered in the personal data storage section 102.

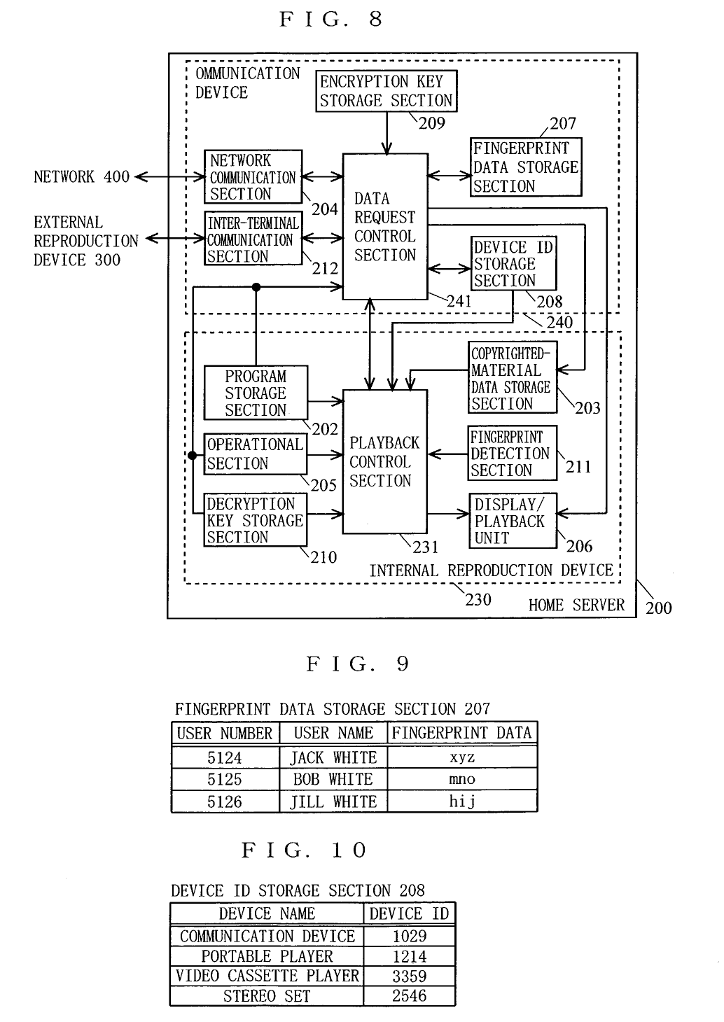

FIG. 8 is a block diagram illustrating the structure of the home server 200 according to the first embodiment of the present invention. In FIG. 8, the home server 200 comprises the communication device 240 and the internal reproduction device 230. The communication device 240 includes a data request control section 241, a network communication section 204, a fingerprint data storage section 207, a device ID storage section 208, an encryption key storage section 209, and an inter-terminal communication section 212. The internal reproduction device 230 includes a playback control section 231, a copyrighted-material data storage section 203, an operational section 205, a display/playback unit 206, a decryption key storage section 210, a fingerprint detection section 211, and a program storage section 202.

The network communication section 204, which comprises a modem or the like, realizes communications between the data request control section 241 and a server 100 via network 400. The inter-terminal communication section 212 realizes communications between the data request control section 241 and an external reproduction device 300 in a wired or wireless manner. The operational section 205, which comprises a keyboard, a mouse, or the like, sends out signals for controlling the operations of the data request control section 241 and the playback control section 231, in accordance with inputs made by the user. The fingerprint detection section 211, which comprises a fingerprint sensor or the like, detects the fingerprint of a finger presented by a user, and sends the detected fingerprint to the playback control section 231 as fingerprint data.

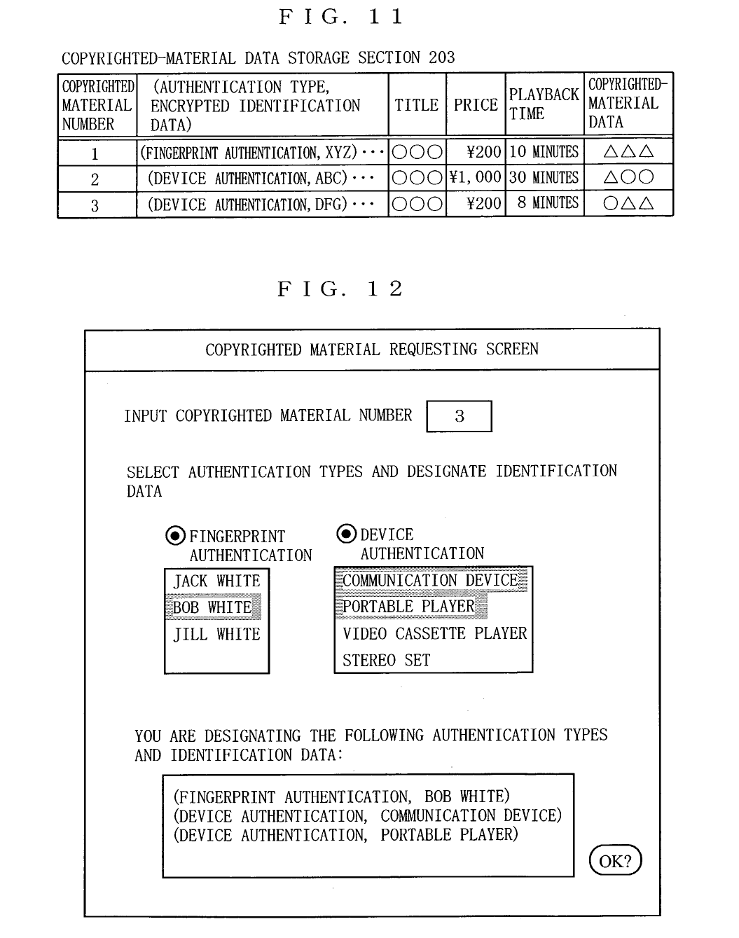

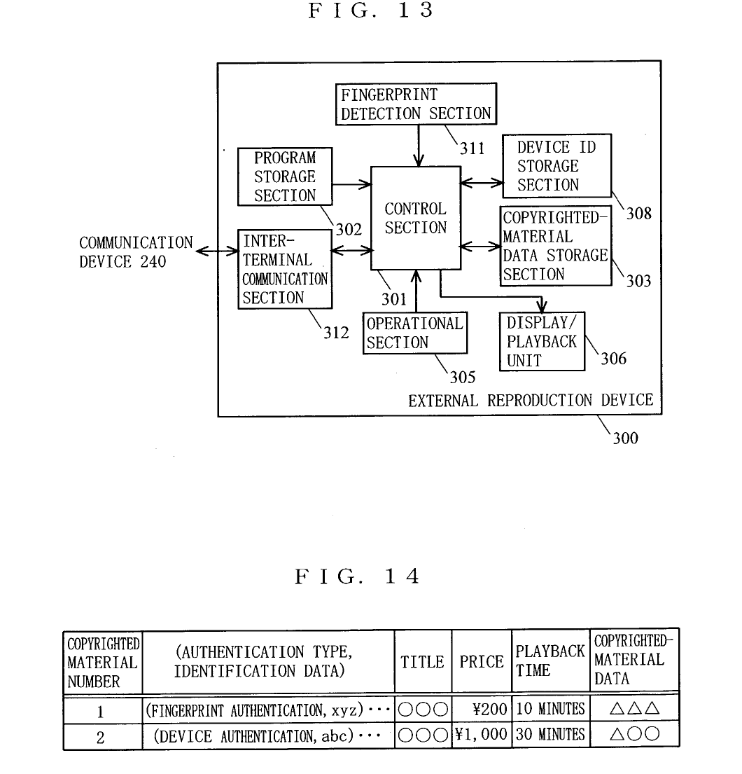

The fingerprint data storage section 207 stores fingerprint data of a user who has the right to use the home server 200. The fingerprint data stored in the fingerprint data storage section 207 has been detected by the fingerprint detection section 211. FIG. 9 is a diagram illustrating an example of the data stored in the fingerprint data storage section 207. As shown in FIG. 9, the fingerprint data storage section 207 stores a user name and fingerprint data in association with each user number.

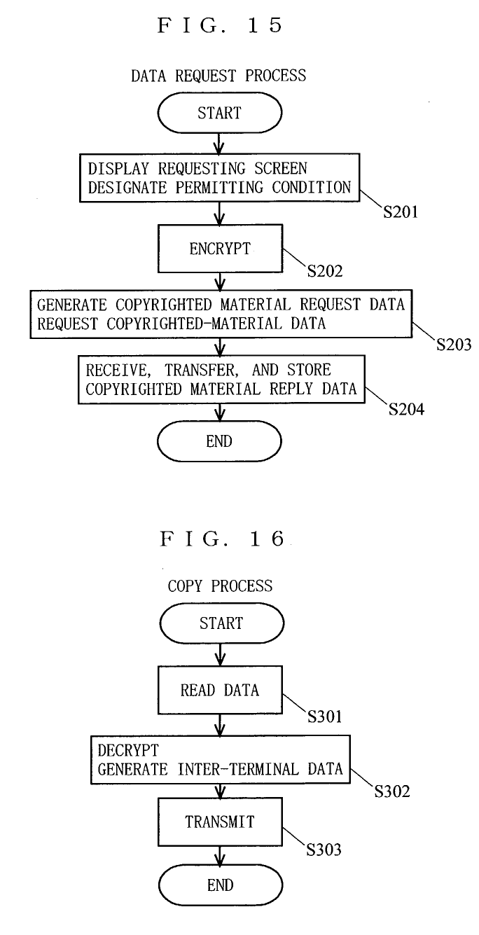

As device IDs, the device ID storage section 208 stores a serial number (e.g., the processor serial number of the CPU) which is unique to the internal reproduction device 230, as well as a serial number which is unique to each and any external reproduction device 300 possessed by the user. FIG. 10 is a diagram illustrating an example of the data stored in the device ID storage section 208. As shown in FIG. 10, the device ID storage section 208 stores device IDs in association with device names.

The encryption key storage section 209 stores an encryption key with which to encrypt identification data. The decryption key storage section 210 stores a decryption key with which to decrypt the encrypted identification data.

The copyrighted-material data storage section 203 stores a plurality of pieces of copyrighted material reply data which have been download by the data request control section 241 from a server 100. FIG. 11 is a diagram illustrating an example of the data stored in the copyrighted-material data storage section 203. As shown in FIG. 11, the copyrighted-material data storage section 203 stores the plurality of pieces of copyrighted material reply data in their entirety. In other words, the copyrighted-material data storage section 203 stores, in association with each copyrighted material number, an authentication type(s), encrypted identification data, a title, a price, a playback time, and copyrighted-material data.

The program storage section 202 stores programs for controlling the operations of the data request control section 241 and the playback control section 231.

By executing a program stored in the program storage section 202, the data request control section 241 performs a process of registering personal information at the server 100, a process of requesting transmission of copyrighted-material data from a server 100 (hereinafter referred to as a “data request process”), and a process of transferring copyrighted-material data to an external reproduction device 300 and making a copy thereof (hereinafter referred to as a “copy process”).

By executing a program stored in the program storage section 202, the playback control section 231 performs a process of displaying/playing back copyrighted-material data (hereinafter referred to as a “data playback process”). The details of the operations of the data request control section 241 and the playback control section 231 will be described later.

The display/playback unit 206, which is a combination of a display, loudspeakers, and the like, displays an operation screen, plays back music, and/or displays images, in accordance with signals sent from the playback control section 231.

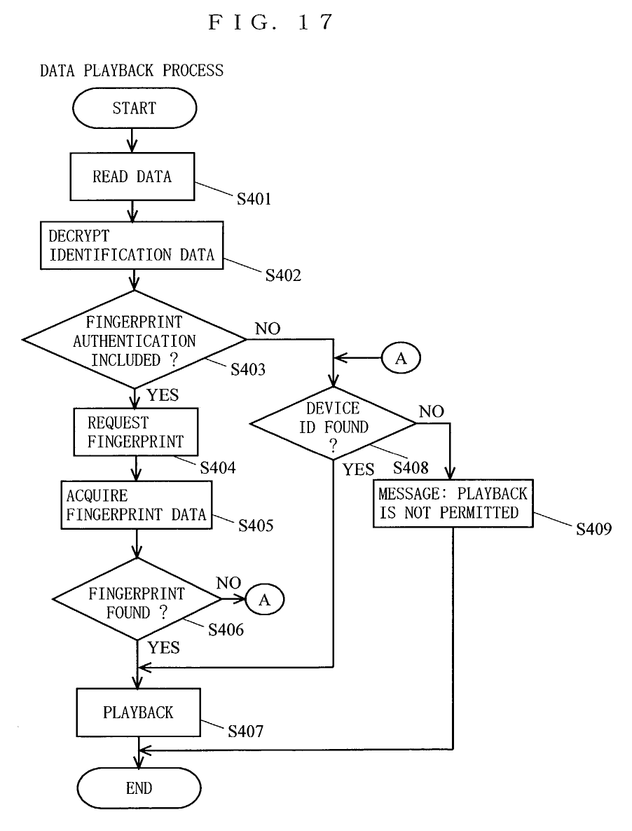

FIG. 12 is a diagram illustrating an exemplary image (hereinafter referred to as “copyrighted material requesting screen”) displayed on a display screen of the display/playback unit 206 when requesting transmission of copyrighted-material data. As shown in FIG. 12, when requesting transmission of copyrighted-material data, a message which prompts the user to input a copyrighted material number (the uppermost section on the screen), a message which prompts the user to select an authentication type(s) and to designate specific identification data (the middle section on the screen), and an indication of the authentication type and identification data that have been designated (the lowermost section on the screen) are displayed.

Prompted by the displayed messages, the user inputs a copyrighted material number, and designates at least one pair of an authentication type and identification data to be used for the authentication of the selected copyrighted-material data. FIG. 12 illustrates an example where “3” is selected as a copyrighted material number; “fingerprint authentication” and “device authentication” are designated as authentication types; the fingerprint data of “Bob White” is selected as identification data for fingerprint authentication; and device IDs of a “communication device” and a “portable player” are selected as identification data for device authentication.

The data request control section 241 displays a list of the designated authentication type(s) and identification data in the lowermost section of the copyrighted material requesting screen. In order to approve the displayed content, the user clicks on an “OK” button. As a result, the data request control section 241 generates contents request data, and transmits it to a server 100.

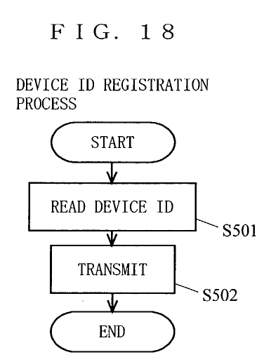

FIG. 13 is a block diagram illustrating the structure of an external reproduction device 300 according to the first embodiment of the present invention. In FIG. 13, the external reproduction device 300 includes a control section 301, a program storage section 302, a copyrighted-material data storage section 303, an operational section 305, a display/playback unit 306, a device ID storage section 308, a fingerprint detection section 311, and an inter-terminal communication section 312.

The inter-terminal communication section 312 realizes communications between the control section 301 and the communication device 240 in a wired or wireless manner. The operational section 305, which comprises operation buttons or the like, sends signals for controlling the operation of the control section 301, in accordance with inputs made by the user. The display/playback unit 306, which is a combination of a liquid crystal display, loudspeakers, and the like, displays an operation screen, plays back music, and/or displays images, in accordance with signals sent from the control section 301. The fingerprint detection section 311, which comprises a fingerprint sensor or the like, detects the fingerprint of a finger presented by the user, and sends the detected fingerprint to the control section 301 as fingerprint data. As a device ID, the device ID storage section 308 stores a serial number which is unique to the external reproduction device 300.

The copyrighted-material data storage section 303 stores inter-terminal data which has been sent from the home server 200. FIG. 14 is a diagram illustrating an example of the data stored in the copyrighted-material data storage section 303. As shown in FIG. 14, the copyrighted-material data storage section 303 stores the inter-terminal data in its entirety. In other words, the copyrighted-material data storage section 303 stores, in association with each copyrighted material number, an authentication type(s), identification data (which is not encrypted), a title, a price, a playback time, and copyrighted-material data.

The program storage section 302 stores a program for controlling the operation of the control section 301.

By executing the program stored in the program storage section 302, the control section 301 performs a process of registering the device ID of the device at the communication device 240 (hereinafter referred to as a “deviceIDregistrationprocess”), and a process of playing back copyrighted-material data (hereinafter referred to as a “device-sidedataplaybackprocess”). The specific operation of the control section 301 will be described later.

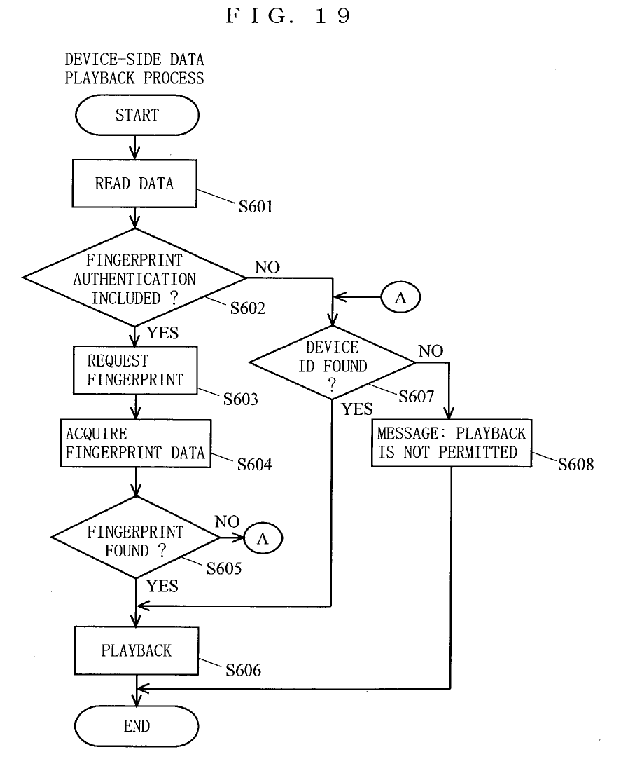

FIG. 15 is a flowchart illustrating a data request process performed by the data request control section 241 of the communication device 240. Hereinafter, by referring to FIG. 15, the operation of the data request control section 241 when performing a data request process will be described. First, the data request control section 241 causes the display/playback unit 206 to display a copyrighted material requesting screen in order to allow the user to designate a copyrighted material number, an authentication type(s) and identification data (step S201).

Next, the data request control section 241 reads the designated identification data from the fingerprint data storage section 207 or from the device ID storage section 208, and encrypts the identification data which has been read, by using the encryption key stored in the encryption key storage section 209 (step S202). Alternatively, the fingerprint data may be directly read from the fingerprint detection section 311.

Next, based on the designated copyrighted material number, authentication type(s), and encrypted identification data, the data request control section 241 generates copyrighted material request data, which is transmitted to a server 100 (step S203). Next, the data request control section 241 receives copyrighted material reply data which has been returned from the server 100, and transfers the received copyrighted material reply data to the internal reproduction device 230 so as to be stored in the copyrighted-material data storage section 203 (step S204), thus ending the process.

FIG. 16 is a flowchart illustrating a copy process performed by the data request control section 241. Hereinafter, with reference to FIG. 16, the operation of the data request control section 241 during a copy process will be described. First, in response to an instruction from the operational section 205 to copy copyrighted-material data, the data request control section 241 reads from the copyrighted-material data storage section 203 an authentication type(s), encrypted identification data, copyrighted-material data, and its associated information (step S301). If there is a plurality of pairs of authentication types and encrypted identification data, the data request control section 241 reads all such pairs.

Next, the data request control section 241 decrypts the encrypted identification data that has been read, by using the decryption key stored in the decryption key storage section 210. The data request control section 241 appends the authentication type(s) and identification data to the copyrighted-material data, thereby generating inter-terminal data (step S302). Then, the data request control section 241 transmits the generated inter-terminal data to an external reproduction device 300 via the inter-terminal communication section 212 (step S303), thus ending the process. The control section 301 of the external reproduction device 300 receiving the inter-terminal data causes the inter-terminal data to be stored in the copyrighted-material data storage section 303.

FIG. 17 is a flowchart illustrating a data playback process performed by the playback control section 231. Hereinafter, with reference to FIG. 17, the operation of the playback control section 231 during a data playback process will be described. First, in response to an instruction from the operational section 205 to play back copyrighted-material data, the playback control section 231 reads, from the copyrighted-material data storage section 203, the copyrighted-material data as well as its corresponding authentication type(s) and encrypted identification data (step S401). If there is a plurality of pairs of authentication types and encrypted identification data, the playback control section 231 reads all such pairs.

Next, the playback control section 231 decrypts all of the identification data that has been read, by using the decryption key stored in the decryption key storage section 210 (step S402). Then, the playback control section 231 determines whether the authentication type(s) that has been read includes “fingerprint authentication” or not (step S403).

If “fingerprint authentication” is included, the playback control section 231 causes the display/playback unit 206 to display a message which prompts the user to present a finger to the fingerprint detection section 211 (step S404). Then, the playback control section 231 acquires fingerprint data from the fingerprint detection section 211 (step S405). Next, the playback control section 231 determines whether or not any fingerprint data that matches the acquired fingerprint data is included in all the decrypt fingerprint data (step S406). If any matching fingerprint data is found, the playback control section 231 causes the display/playback unit 206 to play back the copyrighted-material data (step S407), thus ending the process. On the other hand, if no matching fingerprint data is found, the playback control section 231 proceeds to step S408.

On the other hand, if step S403 finds that “fingerprint authentication” is not included, the playback control section 231 proceeds to step S408.

At step S408, the playback control section 231 determines whether any device ID that matches the device ID of the internal reproduction device 230 itself as stored in the device ID storage section 208 is included among all of the decrypted device IDs (step S408). If any matching device ID is found, the playback control section 231 proceeds to step S407 to play back the copyrighted-material data. On the other hand, if no matching device ID is found, the playback control section 231 causes the display/playback unit 206 to display a message indicating that playback is not permitted (step S409), thus ending the process.

FIG. 18 is a flowchart illustrating a device ID registration process performed by the control section 301 of an external reproduction device 300. Hereinafter, with reference to FIG. 18, the operation of the control section 301 during a device ID registration process will be described. First, in response to an instruction from the operational section 305 to register a device ID, the control section 301 reads the device ID of the external reproduction device 300 itself as stored in the device ID storage section 308 (step S501). Next, the control section 301 transmits the device ID which has been read, together with the device name of the external reproduction device 300 itself, to the communication device 240 via the inter-terminal communication section 312 (step S502), thus ending the process. Upon receiving the device ID, the data request control section 241 of the communication device 240 stores the device ID in the device ID storage section 208, together with the device name.

FIG. 19 is a flowchart illustrating a device-side data playback process performed by the control section 3301 of an external reproduction device 300. Hereinafter, with reference to FIG. 19, the operation of the control section 301 during a device-side data playback process will be described. First, in response to an instruction from the operational section 305 to play back data, the control section 301 reads the copyrighted-material data as well as all of its corresponding authentication type (s) and identification data from the copyrighted-material data storage section 303 (step S601). Next, the control section 301 determines whether or not “fingerprint authentication” is included among the authentication type(s) that has been read (step S602).

If “fingerprint authentication” is included, the control section 301 causes the display/playback unit 306 to display a message which prompts the user to present a finger to the fingerprint detection section 311 (step S603). Then, the control section 301 acquires fingerprint data from the fingerprint detection section 311 (step S604). Next, the control section 301 determines whether any fingerprint data that matches the acquired fingerprint data is included in all the fingerprint data (step S605). If any matching fingerprint data is found, the control section 301 causes the display/playback unit 306 to play back the copyrighted-material data (step S606), thus ending the process. On the other hand, if no matching fingerprint data is found, the control section 301 proceeds to step S607.

On the other hand, if step S602 finds that “fingerprint authentication” is not included, the control section 301 proceeds to step S607.

At step S607, the control section 301 determines whether or not any device ID that matches that of the external reproduction device 300 itself as stored in the device ID storage section 308 is included among all device IDs (step S607). If any matching device ID is found, the control section 301 proceeds to step S606 to play back the copyrighted-material data. On the other hand, if no matching device ID is found, the control section 301 causes the display/playback unit 306 to display a message indicating that playback is not permitted, thus ending the process.

As described above, according to the first embodiment, the communication device 240 allows the user to designate at least one entity (among an individual user, the internal reproduction device 230, and an external reproduction device 300) with respect to whom/which playback permission is requested, and transmits identification data identifying such an entity(s) to a server 100. The server 100 appends the received identification data to the requested copyrighted-material data, so as to be transmitted to the communication device 240. The communication device 240 transfers the copyrighted-material data to the internal reproduction device 230 or transfers it to the external reproduction device 300, with the identification data appended thereto. When playing back the copyrighted-material data, the internal reproduction device 230 or the external reproduction device 300 refers to the identification data appended to the copyrighted-material data to determine whether playback is permitted or not. Thus, the playback of the copyrighted-material data is permitted only with respect to the at least one entity as designated by the user himself/herself. Therefore, unless the user or device that is attempting to play back the copyrighted-material data has such playback permission, the internal reproduction device 230 or external reproduction device 300 cannot play back the copyrighted-material data. As a result, even if the copyrighted-material data is somehow copied beyond private use, the copyrighted-material data cannot be played back for such unauthorized uses. On the other hand, so far as any user and/or device (as originally designated) that has the aforementioned playback permission for the copyrighted-material data is concerned, the internal reproduction device 230 or external reproduction device 300 can play back the copyrighted-material data, thereby allowing for the transfer and copying of the copyrighted-material data within the bounds of private use. Thus, there is provided a data distribution system which permits copying for private use while preventing unauthorized copying.

Although the above embodiment illustrates the home server 200 as an example of a device which downloads copyrighted-material data, such a device may also have a playback function as well as a communication function, e.g., a personal computer or a mobile phone.

The communication device 240 may not only transfer copyrighted-material data to the internal reproduction device 230 but also transfer copyrighted-material data to a memory card drive apparatus or the like, with the permitting condition data appended thereto, such that the copyrighted-material data is stored in the memory card.

Although the above embodiment illustrates an example where the user is allowed to designate an entity (an individual user or a reproduction device) with respect to which playback permission is requested, any other permitting condition, e.g., a maximum allowable number of playback times or a maximum allowable number of copies to be made, may be designated by the user upon use of the copyrighted-material data. In such cases, the use (e.g., playing back or copying) of the copyrighted-material data on the device at which the copyrighted-material data is used may be controlled in accordance with the designated permitting condition.

Note that copyrighted-material data of music, for example, is likely to be used by designating a plurality of pieces of copyrighted-material data at a time and later playing them back one by one. It is conceivable that conducting authentication at the beginning of a playback of each piece of copyrighted-material data, especially in the case of fingerprint authentication, can be very cumbersome. Therefore, in the case of designating a plurality of pieces of copyrighted-material data at a time and later playing them back one by one, the system may be arranged so that all of them are subjected to authentication at the reproduction device where the first playback of the copyrighted-material data is made, thereby reducing the cumbersomeness associated with the authentication process.

Each server 100 may utilize an electronic watermark technique to inseparably embed permitting condition data in the copyrighted-material data itself. In this case, at the reproduction device side, the inseparably embedded permitting condition data is read in order to determine whether playback of the copyrighted-material data is permitted or not. In such a system, if the copyrighted-material data is copied, the permitting condition data will also be copied, which allows the copyright owner to present a warning to whoever has produced an unauthorized copy of the copyrighted-material data, and also provides a basis for ascertaining unauthorized copying. Therefore, voluntary refrainment from unauthorized copying can be expected. Since the permitting condition data is inseparable from the copyrighted-material data, it is impossible to extract only the copyrighted-material data.

The information to be embedded in the copyrighted-material data in the form of an electronic watermark maybe information directly indicating the purchaser (user), e.g., the name of the purchaser (user), instead of permitting condition data.

Although the internal reproduction device 230 and external reproduction devices 300 according to the above embodiment employ fingerprint data as individual identification information, there is no limitation thereto. For example, a password which is only known to the user may be used as individual identification information. Alternatively, encoded data of biological information, such as irises, voiceprints, palmprints, facial contours, may be used as individual identification information. In such a case, the fingerprint data storage section 207 will be replaced by a storage section for storing encoded data of biological information, and the fingerprint detection sections 211 and 311 will be replaced by sensors for detecting biological information (biological information detection sensors), e.g., iris detection sensors, voiceprint detection sensors, palmprint detection sensors, or facial contour detection sensors. Thus, individual authentication based on biological information can be performed.

(Second Embodiment)

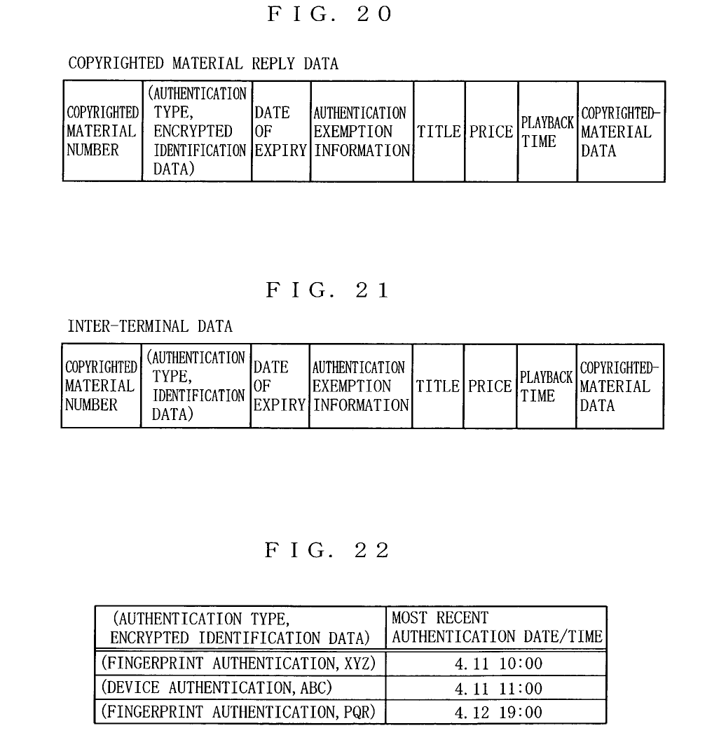

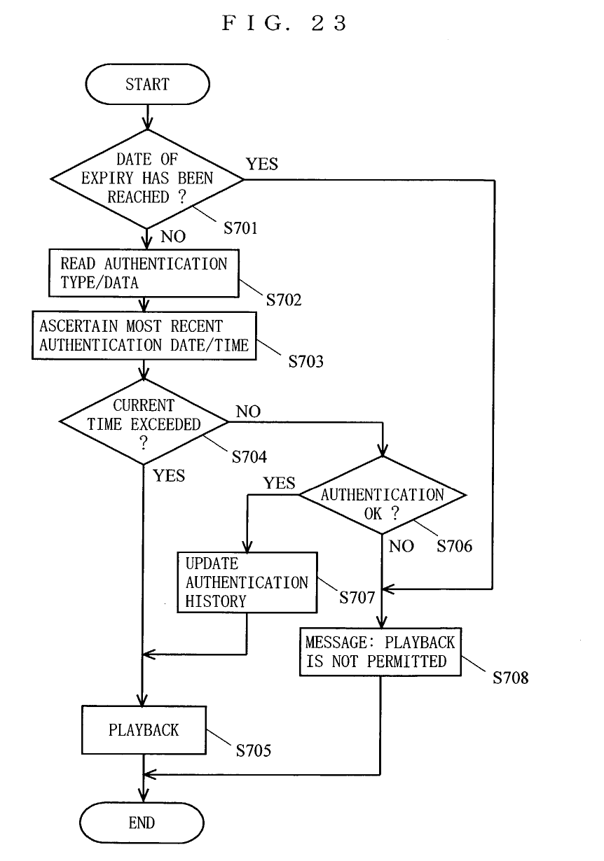

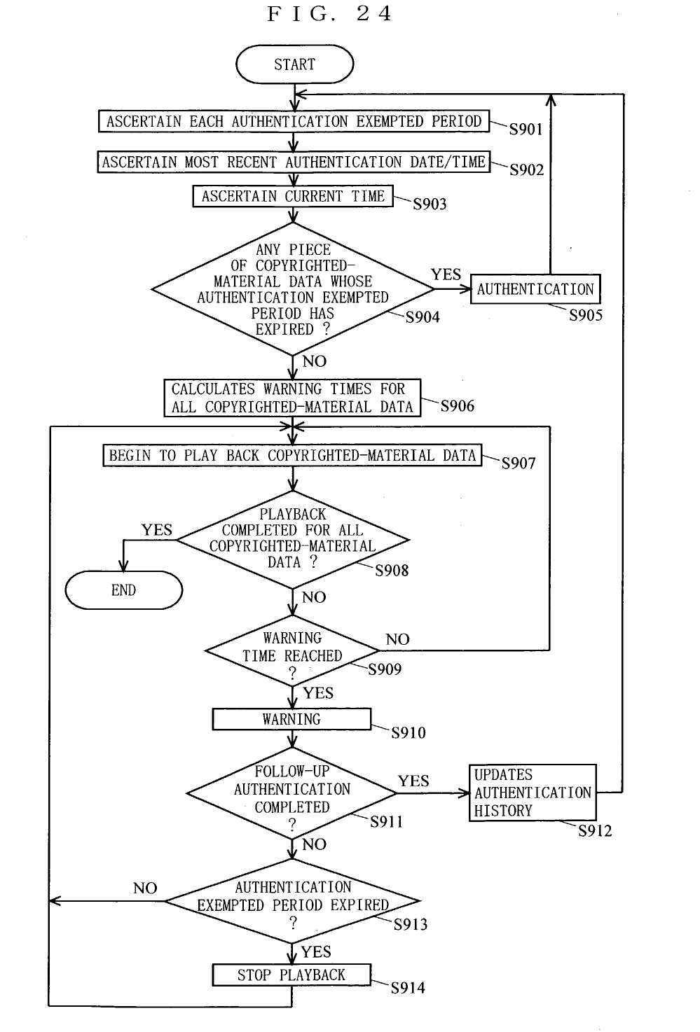

A data distribution system according to a second embodiment of the present invention hasa similar overall structure to that of the data distribution system according to the first embodiment, and therefore will be described with reference to FIG. 1. Hereinafter, differences from the first embodiment will mainly be described. The copyrighted material request data according to the second embodiment is similar to that according to the first embodiment, and therefore will be described with reference to FIG. 2. The copyrighted material reply data and the inter-terminal data according to the second embodiment are different from those according to the first embodiment. FIG. 20 is a diagram illustrating the structure of copyrighted material reply data according to the second embodiment. FIG. 21 is a diagram illustrating the structure of inter-terminal data according to the second embodiment.

As shown FIG. 20, the copyrighted material reply data contains, a copyrighted material number, an authentication type(s), encrypted identification data, a date of expiry, authentication exemption information, a title, a price, and a playback time, in association with copyrighted-material data. The date of expiry represents a period within which playback of the stored copyrighted-material data is permitted. The authentication exemption information represents a condition concerning a period during which authentication needed for playing back the copyrighted-material data is exempted. During such a period, referred to as an “authentication exempted period”, the internal reproduction device 230 or an external reproduction device 300 is allowed to play back copyrighted-material data without having to perform an authentication process. Thus, the authentication exemption information contains a condition for allowing omission of the process of determining whether playback of the copyrighted-material data is permitted (hereinafter referred to as “exempting condition”).

As shown in FIG. 21, the inter-terminal data contains a copyrighted material number, an authentication type(s), identification data, a date of expiry, authentication exemption information, a title, a price, and a playback time, in association with copyrighted-material data. The inter-terminal data is a decrypted version of the encrypted identification data contained in the copyrighted material reply data.

See FIG. 5 for the block structure of a server 100 according to the second embodiment, except that the copyrighted-material data storage section 103 according to the second embodiment stores a date of expiry and authentication exemption information in association with copyrighted-material data.

See FIG. 8 for the block structure of home server 200 according to the second embodiment second embodiment, except that the internal reproduction device 230 includes an authentication history storage section (not shown) in addition to the blocks illustrated in FIG. 8.

For each pair of an authentication type and encrypted identification data, the authentication history storage section stores a date and time when an authentication process was last performed based on that pair, as a most recent authentication date/time. FIG. 22 is a diagram illustrating an example of the data stored in an authentication history storage section. This example indicates, for instance, that the most recent authentication date/time for fingerprint authentication based on encrypted identification data “XYZ” is “April 11, 10:00”.

When playing back the copyrighted-material data, the playback control section 231 determines whether authentication can be omitted or not, based on the authentication exemption information appended to the copyrighted-material data, the current time, and the most recent authentication date/time stored in the authentication history storage section. As for any copyrighted-material data for which authentication can be omitted, the playback control section 231 plays back such copyrighted-material data without performing an authentication process.

See FIG. 13 for the block structure of an external reproduction device 300 according to the second embodiment second embodiment, except that the external reproduction device 300 includes an authentication history storage section (not shown) in addition to the blocks illustrated in FIG. 13. The authentication history storage section is similar to that in the internal reproduction device 230. As is the case with the internal reproduction device 230, the control section 301 refers to the authentication exemption information to determine whether authentication can be omitted or not, and as for any copyrighted-material data for which authentication can be omitted, the control section 301 plays back such copyrighted-material data without performing an authentication process.

FIG. 23 is a flowchart illustrating an operation of the internal reproduction device 230 or an external reproduction device 300 when playing back copyrighted-material data. Since the operations of the internal reproduction device 230 and an external reproduction device 300 when playing back copyrighted-material data are basically identical, only the playback operation of the internal reproduction device 230 will be described with reference to FIG. 23, with additional notes on any characteristic operation that is unique to the external reproduction device 300.

First, by referring to the copyrighted-material data storage section 203, the playback control section 231 of the internal reproduction device 230 determines whether the date of expiry has been reached with respect to the copyrighted-material data to be played back (step S701). If the date of expiry has been reached, the playback control section 231 proceeds to step S708.

On the other hand, if the date of expiry has not been reached, the playback control section 231 reads an authentication type and encrypted identification data (or identification data, in the case of the external reproduction device 300) for the copyrighted-material data to be played back (step S702). Next, the playback control section 231 refers to the authentication history storage section to ascertain the most recent authentication date/time corresponding to the pair of an authentication type and encrypted identification data that has been read (step S703).

Next, the playback control section 231 determines whether a point in time as calculated by adding the authentication exempted period to the most recent authentication date/time has exceeded the current time (step S704). If the current time has been exceeded, the playback control section 231 determines that the current time falls within the authentication exempted period, and therefore plays back the copyrighted-material data without performing an authentication process (step S705), thus ending the process.

On the other hand, if the current time has not been exceeded, the playback control section 231 determines that the current time no longer falls within the authentication exempted period, and therefore proceeds to step S706 to perform an authentication process. In the process of step S706, the playback control section 231 decrypts all of the encrypted identification data (note that such decryption is not necessary at the external reproduction device 300), and determines whether the fingerprint data of the user as detected by the fingerprint detection section 211 is contained in the identification data, or whether a device ID of the internal reproduction device 230 itself as stored in the device ID storage section 208 (or the external reproduction device 300 itself in the device ID storage section 308) is contained in the identification data, thereby determining whether authentication is successfully made or not. The process of step S706 corresponds to steps S402 to S406 and S408 (or steps S602 to S605 and S607, in the case of the external reproduction device 300) in the first embodiment, shown in FIG. 17 (or FIG. 19, in the case of the external reproduction device 300).

If step S706 finds that authentication has been successfully made, the playback control section 231 updates the most recent authentication date/time stored in the authentication history storage section (step S707), and proceeds to step S705 to play back the copyrighted-material data. On the other hand, if step S706 finds that authentication has failed, the playback control section 231 proceeds to step S708.

At step S708, the playback control section 231 causes the display/playback unit 206 to display a message indicating that playback of the copyrighted-material data is not permitted, thus ending the process.

Thus, according to the second embodiment, authentication for playing back copyrighted-material data is omitted within a predetermined authentication exempted period. As a result, within the authentication exempted period, the user is able to play back the copyrighted-material data without having to take the trouble of presenting a finger to the fingerprint detection section 211 or the like, which adds to the convenience of the system.

This also makes it possible to satisfy the desire of the provider of the copyrighted-material data to adjust the frequency of performing authentication for play backing copyrighted-material data as necessary.

In an application where a plurality of pieces of copyrighted-material data (each requiring a relatively short playback time) are designated at a time so as to be later played back one by one, the reproduction device may check the playback time of each piece of copyrighted-material data to determine during the playback of which one of the plurality of copyrighted-material data the authentication exempted period will expire. Then, if it is detected that the authentication exempted period will expire during the playback of any piece of copyrighted-material data, it may be ensured that the initial authentication encompasses such a piece of copyrighted-material data, as well as any preceding pieces of copyrighted-material data.

(Variant of the Second Embodiment)

As for copyrighted material data having a relatively long playback time, e.g., movies, the provider of such copyrighted-material data may desire to perform authentication several times, even during the playback of the copyrighted-material data, in order to confirm whether the playback is being made by an authorized user. Hereinafter, variant operations of the internal reproduction device 230 and an external reproduction device 300, which enable authentication to be performed for copyrighted-material data having a relatively long playback time during the playback thereof, but in an manner not leading to an actual interruption of the playback, will be described.

FIG. 24 is a flowchart illustrating an operation of the internal reproduction device 230 or an external reproduction device 300 when playing back a plurality of pieces of copyrighted-material data having a long playback time. Since the operations of the internal reproduction device 230 and the external reproduction device 300 are similar, the operation of only the internal reproduction device 230 will be mainly described with reference to FIG. 24.

First, the playback control section 231 of the internal reproduction device 230 refers to the copyrighted-material data storage section 303 to ascertain the authentication exempted periods of the plurality of pieces of copyrighted-material data to be played back (step S901). Next, the playback control section 231 refers to the authentication history storage section to ascertain the most recent authentication date/time corresponding to the pair of an authentication type and encrypted identification data that are designated for each piece of copyrighted-material data to be played back (step S902). Next, the playback control section 231 determines the current time (step S903).

Next, the playback control section 231 compares the most recent authentication date/time for each piece of copyrighted-material data against the current time, thereby determining whether there is any piece of copyrighted-material data whose authentication exempted period has expired (step S904). If there is any piece of copyrighted-material data whose authentication exempted period has expired, the playback control section 231 performs authentication (step S905), and returns to step S901. On the other hand, if there is no piece of copyrighted-material data whose authentication exempted period has expired, the playback control section 231 proceeds to step S906.

At step S906, for every piece of copyrighted-material data to be played back, the playback control section 231 calculates a warning time by subtracting a predetermined notice time (e.g., five minutes) from a point in time calculated by adding the authentication exempted period to the most recent authentication date/time. In other words, the warning time=most recent authentication date/time+authentication exempted period−notice time.

Next, the playback control section 231 begins to play back the copyrighted-material data in accordance with a predetermined playing back order (step S907). Then, the playback control section 231 determines whether the playback has been completed for all pieces of copyrighted-material data (step S908) If playback has been completed for all pieces of copyrighted-material data, the playback control section 231 ends its operation. On the other hand, if playback has not been completed, the playback control section 231 determines whether a warning time has been reached with respect to any piece of copyrighted-material data (step S909).

If the warning time has not been reached, the playback control section 231 returns to step S907 to continue to play back the copyrighted-material data. On the other hand, if the warning time has been reached, the playback control section 231 causes the display/playback unit 206 to display a warning message to prompt the user to perform authentication (hereinafter, such an authentication will be referred to as “a follow-up authentication”) (step S910). In the case where the authentication type is device authentication, however, the playback control section 231 performs device authentication at step S910 by referring to the device ID storage section 208, without displaying any message authentication.

Next, the playback control section 231 determines whether a follow-up authentication has been completed or not (step S911). If a follow-up authentication has been completed, the playback control section 231 updates the content of the authentication history storage section (step S912), and returns to step S901. On the other hand, if a follow-up authentication has not been completed, the playback control section 231 determines whether the authentication exempted period of the piece of copyrighted-material data for which the warning time has been reached has expired or not (step S913). If the authentication exempted period has not expired, the playback control section 231 returns to step S907 and continues to play back the copyrighted-material data. On the other hand, if the authentication exempted period has expired, the playback control section 231 discontinues the playback of only the piece of copyrighted-material data whose authentication exempted period has expired (step S914), and returns to step S907 to continue to play back the other pieces of copyrighted-material data.

Thus, in the case of playing back copyrighted-material data having a relatively long playback time, the internal reproduction device 230 or the external reproduction device 300 calculates a warning time, based on which the external reproduction device 300 requests the user to perform a follow-up authentication before the authentication exempted period actually expires. Once a follow-up authentication is performed, the playback of the copyrighted-material data will not be interrupted.

In the case where a plurality of pieces of copyrighted-material data having a relatively long playback time are played back, the playback of only the copyrighted-material data whose authentication exempted period has expired is discontinued, while the other pieces of copyrighted-material data are still allowed to continue to be played back.

Although the above description assumes a case where the playback of a plurality of pieces of copyrighted-material data is designated at a time, the same operation is also applicable to the playback of a single piece of copyrighted-material data. It will also be appreciated that the same operation is also applicable to copyrighted-material data which does not require a long playback time.

(Third Embodiment)

A third embodiment of the present invention makes it possible to purchase copyrighted-material data on a family or group basis. Once copyrighted-material data is purchased on a family or group basis, all users belonging to that family or group are allowed to play back the copyrighted-material data. While the following description is directed to family purchasing, it will be appreciated that the same principle of purchasing is also applicable to any other type of group.

A data distribution system according to the third embodiment of the present invention has a similar overall structure to that of the data distribution system according to the first embodiment, and therefore will be described with reference to FIG. 1. See FIGS. 5 and 8, respectively, for the block structures of a server 100 and a home server 200 according to the third embodiment.

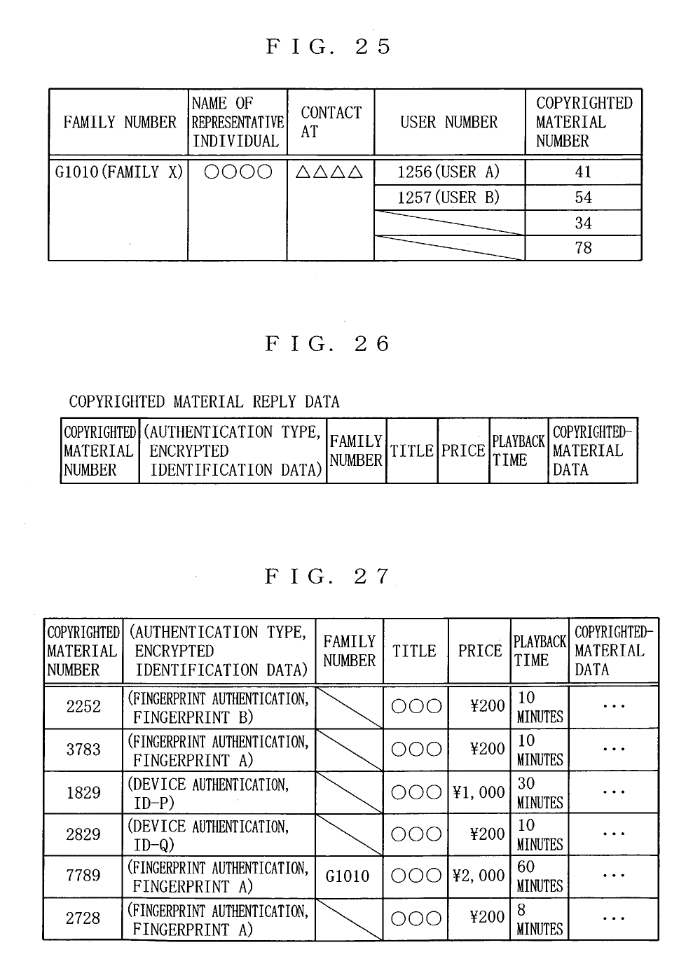

The personal data storage section 102 of the server 100 according to the third embodiment stores family data in addition to the data illustrated above with respect to the first embodiment. FIG. 25 is a diagram illustrating an example of family data. As shown in FIG. 25, the family data contains, in association with a family number, the name of a representative individual, where the representative individual can be reached, user numbers of users belonging to the same family, and copyrighted material numbers of the copyrighted-material data purchased by the family.

FIG. 26 is a diagram illustrating the data structure of copyrighted material reply data according to the third embodiment of the present invention. As shown in FIG. 26, the copyrighted material reply data is the same as that in the first embodiment except that it contains a family number, which is given once copyrighted-material data is purchased on a family basis.

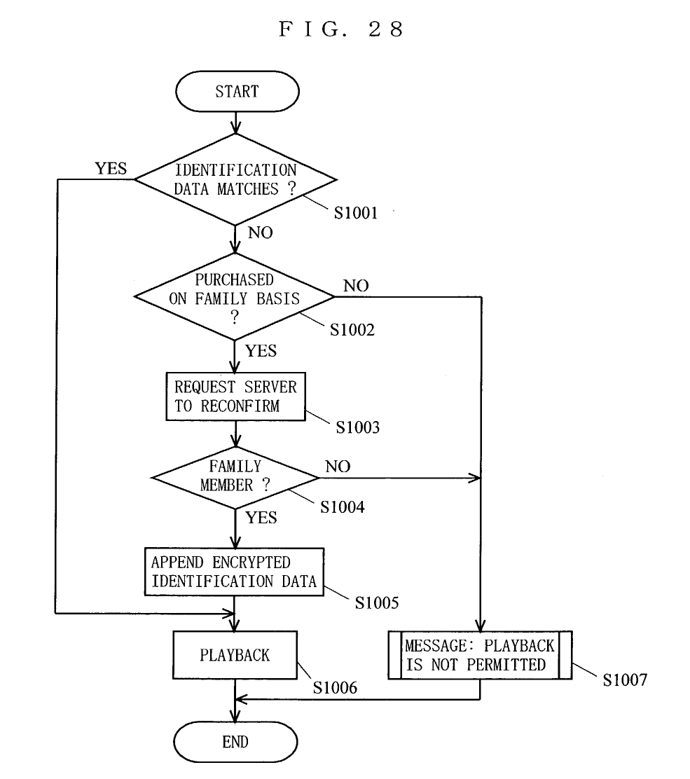

FIG. 27 is a diagram illustrating an example of the data stored in the copyrighted-material data storage section 203 of the internal reproduction device 230 according to the third embodiment of the present invention. As shown in FIG. 27, once purchased on a family basis, copyrighted-material data is stored with a family number appended thereto. Note that no family number is appended to copyrighted-material data which has not been purchased on a family basis.

FIG. 28 is a flowchart illustrating an operation of the internal reproduction device 230 when playing back copyrighted-material data. Hereinafter, with reference to FIG. 28, the operation of the internal reproduction device 230 when playing back copyrighted-material data will be described.

First, the playback control section 231 of the internal reproduction device 230 extracts all of the authentication types and encrypted identification data stored in the copyrighted-material data and decrypts it, and determines whether the identification data matches the fingerprint data detected by the fingerprint detection section 211 or a device ID of the internal reproduction device 230 itself as stored in the device ID storage section 208 (step S1001). If they match, playback control section 231 proceeds to step S1006 to cause the display/playback unit 206 to play back the copyrighted-material data to.

On the other hand, if they do not match, the playback control section 231 proceeds to step S1002, where the playback control section 231 determines, by referring to the copyrighted-material data storage section 203, whether the copyrighted-material data has been purchased on a family basis or not (based on whether a family number is appended to the copyrighted-material data or not) (step S1002). If the copyrighted-material data has not been purchased on a family basis, the playback control section 231 proceeds to step S1007.

On the other hand, if the copyrighted-material data has been purchased on a family basis, the playback control section 231 requests the server 100 to again confirm whether or not the user attempting to play back the copyrighted-material data is a member of the family which has purchased the copyrighted-material data on a family basis (step S1003). In response to this request, the control section 101 of the server 100 determines whether the aforementioned user is a member of the family or not by referring to the personal data storage section 102, and notify the result of the determination to the home server 200.

Based on a notification from the server 100, the playback control section 231 determines whether or not the user attempting to play back the copyrighted-material data is a member of the family (step S1004). If the aforementioned user is not a family member, the playback control section 231 proceeds to step S1007. On the other hand, if the aforementioned user is a family member, the playback control section 231 appends the authentication type(s) and encrypted identification data as originally designated to the copyrighted-material data to be played back, causes it to be stored in the copyrighted-material data storage section 203 (step S1005), and proceeds to step S1006 to cause the display/playback unit 206 to play back the copyrighted-material data.

At step S1007, the playback control section 231 causes the display/playback unit 206 to display a message indicating that playback of the copyrighted-material data is not permitted, thus ending the process.

Thus, the copyrighted-material data which is purchased on a family or group basis can be played back by any member of the family or group. As a result, if the copyrighted-material data which has been downloaded by a member of the family or group is copied for use within the family or group, the copyrighted-material data can still be played back. This enables intra-family or intra-group use of the copyrighted-material data. The third embodiment has a high practicality because copying of copyrighted-material data within a family is generally permitted by the copyright law.

Note that the above-described operation can also be applied to any external reproduction device 300 which is capable of communicating with the communication device 240.

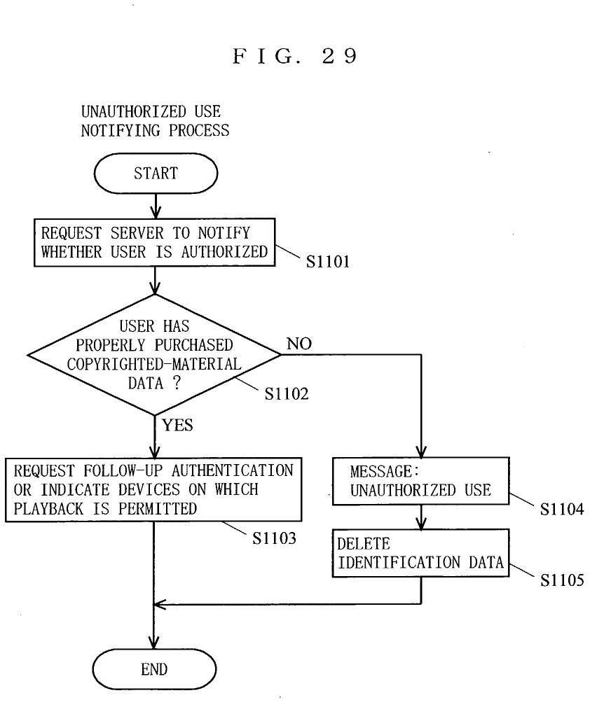

At step S1007, encrypted identification data may be deleted in response to a notification that playback is not permitted. FIG. 29 is a flowchart illustrating an operation of the internal reproduction device 230 in a variant where step S1007 involves deletion of encrypted identification data. Hereinafter, with reference to FIG. 29, the operation of the internal reproduction device 230 in the case where step S1007 involves deletion of encrypted identification data will be described.

First, via the communication device 240, the playback control section 231 requests the server 100 to again confirm and notify whether the user attempting to play back the copyrighted-material data is a user who has properly purchased the copyrighted-material data (step S1101). Next, based on a notification from the server 100, the playback control section 231 determines whether the aforementioned user is a user who has properly purchased the copyrighted-material data (step S1102). If the user has properly purchased the copyrighted-material data, the playback control section 231 requests follow-up authentication of the fingerprint data, or indicates to the user the device(s) on which the copyrighted-material data is allowed to be played back (step S1103), thus ending the process. On the other hand, if the user has not properly purchased the copyrighted-material data, the playback control section 231 causes the display/playback unit 206 to indicate that an unauthorized use is being attempted (step S1104), and deletes the encrypted identification data which is appended to the copyrighted-material data (step S1105), thus ending the process. Once the encrypted identification data is deleted, the playback control section 231 determines that the playback of the copyrighted-material data is not permitted, so that the copyrighted-material data can no longer be played back.

Thus, according to this variant, if it is determined that a given piece of copyrighted-material data cannot be played back, the internal reproduction device 230 requests the server 100 to determine whether the person attempting to play back the copyrighted-material data has properly purchased the copyrighted-material data or not. If it is determined that the person has not properly purchased the copyrighted-material data, the person is deemed to have obtained the copyrighted-material data in an unauthorized manner, e.g., through unauthorized copying, and therefore the internal reproduction device 230 deletes the encrypted identification data appended to the copyrighted-material data. This prevents foul use of the identification data which is appended to any copyrighted-material data that has been replicated through unauthorized copying. Note that since the copyrighted-material data is not deleted, the playback of the copyrighted-material data is still possible once a proper authentication is made at the server.

Alternatively, all data, including the copyrighted-material data itself, may be deleted when an unauthorized attempt to play back the copyrighted-material data is detected in the above-described manner. In this case, any copyrighted-material data that has once been replicated through unauthorized copying can no longer be fully played back.

(Fourth Embodiment)

A data distribution system according to a fourth embodiment of the present invention has a similar overall structure to that of the data distribution system according to the first embodiment, and therefore will be described with reference to FIG. 1. The block structure of the server 100 according to the fourth embodiment is identical to that according to the first embodiment except that a location information history storage section (not shown) is additionally comprised.

FIG. 30 is a diagram illustrating an example of the data stored in the location information history storage section. As shown in FIG. 30, in association with each user number, the location information history storage section stores authentication times, longitudes, latitudes, and hypothetical travelling velocities.

The block structure of the internal reproduction device 230 according to the fourth embodiment is identical to that according to the first embodiment except that a location information detection section (not shown) for detecting the longitude/latitude of a current location is additionally comprised. When performing authentication as to a playback of copyrighted-material data, the playback control section 231 of the internal reproduction device 230 transmits a longitude and a latitude detected by the location information detection section (hereinafter referred to as “authentication location identifying information”) to a server 100, via the communication device 240. The server 100 having received the authentication location identifying information stores the time at which the authentication location identifying information is received as an “authentication time” in the location information history storage section, together with the received longitude and latitude.

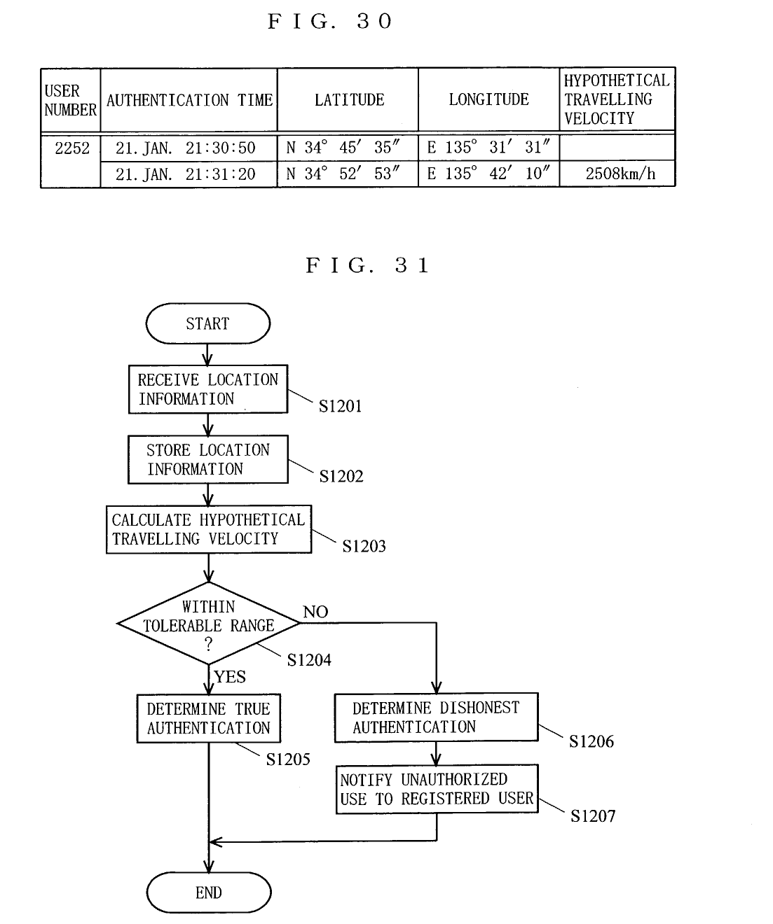

FIG. 31 is a flowchart illustrating an operation of the server 100 when receiving authentication location identifying information. Hereinafter, with reference to FIG. 31, the operation of the server 100 when receiving authentication location identifying information will be described.

First, the control section 101 of the server 100 receives authentication location identifying information which is transmitted from the home server 200 (step S1201). Next, the control section 101 causes the location information and authentication time to be stored in the location information history storage section (step S1202) Then, by referring to the location information history storage section, the control section 101 ascertains the longitude and latitude associated with the previously-received (most recent) authentication time, and compares them against the longitude and latitude which have just been received from the home server 200, and calculates a travelling velocity for a hypothetical trip from a location indicated by the previous set of longitude and latitude to a location (i.e., current location) indicated by the current set of longitude and latitude (step S1203).

Next, the control section 101 determines whether the hypothetical travelling velocity is within a tolerable range or not (step S1204). If the hypothetical travelling velocity is found to be within the tolerable range, the control section l01 determines that a true authentication has been made (step S1205), thus ending the process. On the other hand, if the hypothetical travelling velocity is not found to be within the tolerable range, the control section 101 determines that the authentication has been made in a dishonest manner (step S1206), and notifies an unauthorized use to the home server 200 (step S1207), thus ending the process.

Upon receiving a notification of an unauthorized use, the home server 200 indicates a warning message to the user.

When a given piece of copyrighted-material data has been replicated onto an other device on the Internet through unauthorized copying, by a person who then dishonestly attempts an authentication, this situation can be hypothetically viewed as having been performed by a single user who has traveled at a very fast speed from one authentication location to another. If such a hypothetical travel is determined to have been made at an intolerably high speed, the server 100 determines that the copyrighted-material data has been replicated through unauthorized copying over a network by a person who has attempted a dishonest authentication. Thus, based on location information concerning devices at which copyrighted-material data is played back, the server 100 can calculate a hypothetical travel between authentication locations, based on which an unauthorized copying can be indirectly recognized. As a result, voluntary refrainment from unauthorized copying of copyrighted-material data over a network can be expected.

The technique according to the fourth embodiment of notifying an authentication location to a server can be applied not only when a play back of copyrighted-material data is attempted but also at any other moment. For example, with respect to any authentication which is made between the communication device and a server over a network, the communication device may transmit location information to the server at the time of performing an authentication process, and the server may determine a hypothetical travel as defined above, thereby detecting a dishonest authentication.

Note that the above-described operation can also be applied to any external reproduction device 300 which is capable of communicating with the communication device 240.

Alternatively, when downloading copyrighted-material data from a server 100, the internal reproduction device 230 may store location information in association with the copyrighted-material data, and compare the current location information against the location information associated with the copyrighted-material data when playing back the copyrighted-material data, thereby determining an unauthorized playback attempt on its own. Specifically, the playback control section 231 may calculate a hypothetical travelling velocity based on the location information obtained at the time of downloading relative to the location information obtained at the time of playback, and prevent the copyrighted-material data from being played back unless the hypothetical travelling velocity is found to be within a tolerable range.

(Fifth Embodiment)

In any of the above-described embodiments, identification data is merely appended in the header portion of the copyrighted-material data. Therefore, an ill-willed third party may somehow isolate the copyrighted-material data and use the copyrighted-material data after being isolated. The fifth embodiment of the present invention provides an improvement in this respect.

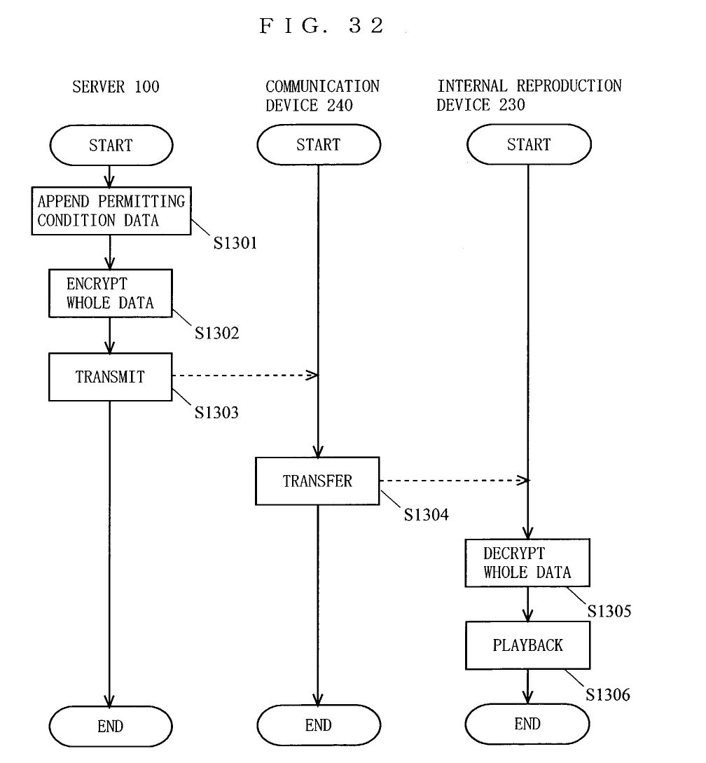

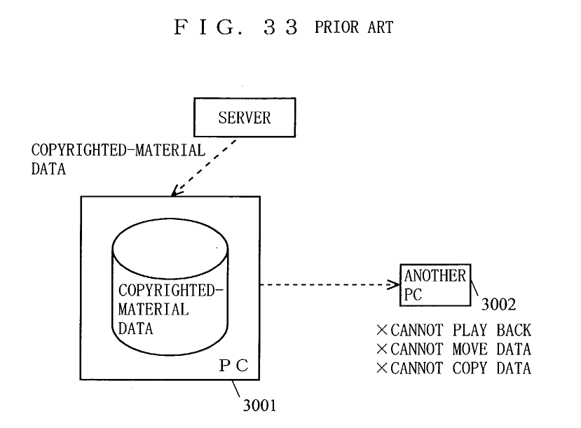

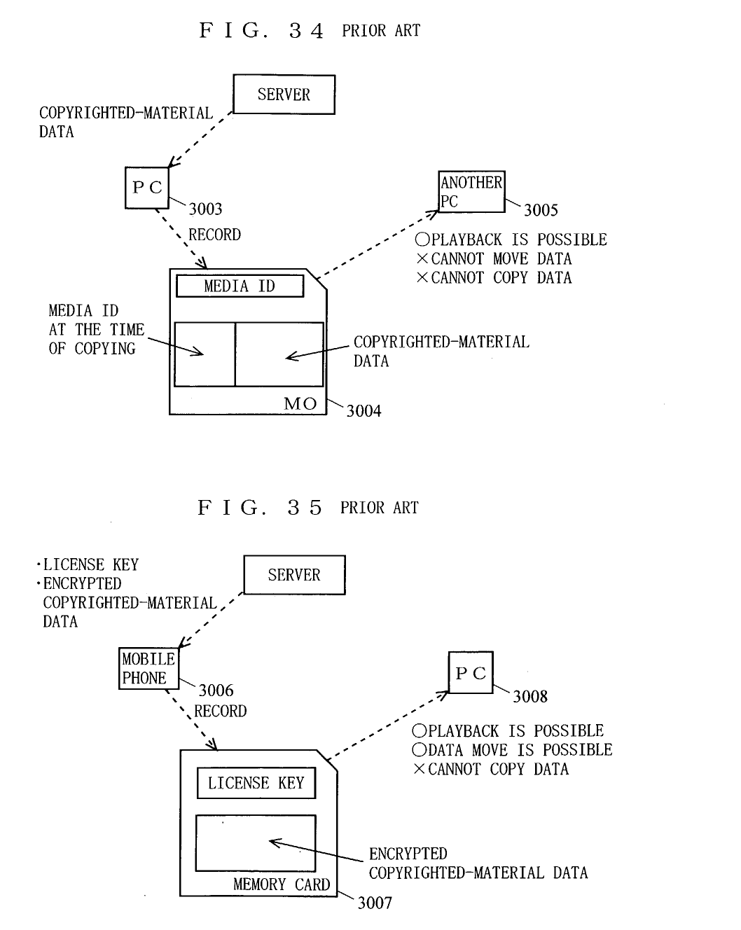

FIG. 32 is a flowchart illustrating operations of a server 100, the communication device 240, and the internal reproduction device 230 according to the fifth embodiment of the present invention. Hereinafter, with reference to FIG. 32, the operations of the communication device 240 and the internal reproduction device 230 will be described. The operation of an external reproduction device 300 is similar to that of the internal reproduction device 230, and the description thereof is omitted. The process of requesting copyrighted-material data, performed by the communication device 240, is similar to that according to the first embodiment.

First, in response to a request from the communication device 240, the server 100 acquires copyrighted-material data, and appends the permitting condition data (an authentication type(s) and identification data) thereto (step S1301). The server 100 may append the permitting condition data in the header of the copyrighted-material data, or append the permitting condition data as an inseparable electronic watermark in the copyrighted-material data. Next, the server 100 encrypts the copyrighted-material data together with the appended permitting condition data (step S1302). Then, the server 100 transmits the encrypted permitting condition data and permitting condition data to the communication device 240 (step S1303), thus ending the process. It is assumed that a key for decrypting the data which has been encrypted at the server 100 is previously (at the time of user registration) registered in the internal reproduction device 230 and external reproduction devices 300.

Having received the data from the server 100, the communication device 240 transfers the received encrypted data to the internal reproduction device 230 (or the external reproduction device 300) (step S1304), without decrypting it, thus ending the process. When playing back the copyrighted-material data, the internal reproduction device 230 (or the external reproduction device 300) decrypts the copyrighted-material data and permitting condition data, by using the preregistered decryption key (step S1305). Next, the internal reproduction device 230 (or the external reproduction device 300) determines whether or not playback is permitted by referring to the decrypt permitting condition data, and plays back the decrypted copyrighted-material data (step S1306), thus ending the process.

Thus, according to the fifth embodiment, copyrighted-material data and appended permitting condition data are encrypted together, so that the permitting condition data is inseparable from the copyrighted-material data. As a result, the copyrighted-material data itself cannot be isolated.

When the copyrighted-material data is transferred to an external reproduction device 300, such a transfer is also made without decrypting the copyrighted-material data. As a result, it becomes possible to prevent unauthorized copying of copyrighted-material data while permitting copying for private use.

(Sixth Embodiment)

A data distribution system according to a sixth embodiment of the present invention has a similar overall structure to that of the data distribution system according to the first embodiment, and therefore will be described with reference to FIG. 1. Hereinafter, only the differences from the first embodiment will be described.

In the sixth embodiment, encrypted identification data is preregistered in a storage device in the server, with respect to each user. When requesting a transmission of copyrighted-material data, the communication device notifies a user number and an authentication type(s) as a permitting condition to a server. Based on the permitting condition (the user number and authentication type(s)), the server reads the corresponding encrypted identification data from the storage device. The server regards the authentication type(s) and the encrypted identification data that have been read as the permitting condition data. Then, the server generates copyrighted material reply data by appending the permitting condition data to the copyrighted-material data, and transmits the generated copyrighted material reply data to the communication device.

The communication device decrypts the identification data in a manner similar to the first embodiment, and transfers inter-terminal data to the internal reproduction device or to an external reproduction device. The internal reproduction device or external reproduction device determines whether playback is permitted or not based on the authentication type(s) and identification data, and plays back the copyrighted-material data if playback is permitted.

Thus, according to the sixth embodiment, the server generates copyrighted material reply data containing permitting condition data, by using the encrypted identification data which is preregistered in its own storage device. The user is freed from the cumbersome task of having to transmit permitting condition data via the communication device each time requesting a transmission of copyrighted-material data.

It will be appreciated that the operation according to the sixth embodiment, where the server generates copyrighted material reply data containing permitting condition data by using the encrypted identification data which is preregistered within the server itself, may also be adopted in the second to fifth embodiments.

While the invention has been described in detail, the foregoing description is in all aspects illustrative and not restrictive. It is understood that numerous other modifications and variations can be devised without departing from the scope of the invention.

What is claimed is:

1. A data distribution system comprising a server and a communication device, the server storing copyrighted-material data obtained by encoding a copyrighted material, such that the server distributes the copyrighted-material data to the communication device over a network in response to a request from the communication device,
wherein,
the communication device comprises:
permitting condition designation means for allowing a user to designate a permitting condition based on which to permit use of the copyrighted-material data; and
copyrighted-material data requesting means for notifying to the server the permitting condition designated via the permitting condition designation means, and requesting transmission of a desired piece of copyrighted-material data, and
the server comprises:
copyrighted-material data acquisition means for acquiring the desired piece of copyrighted-material data in accordance with the request from the copyrighted-material data requesting means; and
copyrighted-material data transmission means for transmitting to the communication device the copyrighted-material data acquired by the copyrighted-material data acquisition means, such that permitting condition data based on the permitting condition notified from the communication device is appended to the transmitted copyrighted-material data,
wherein the communication device further comprises:
copyrighted-material data reception means for receiving the copyrighted-material data transmitted from the copyrighted-material data transmission means with the appended permitting condition data; and
copyrighted-material data transfer means for transferring the copyrighted-material data received by the copyrighted-material data reception means to an external device, with the permitting condition data appended to the transferred copyrighted-material data,
wherein the permitting condition data appended to the copyrighted-material data is used to determine whether or not to permit playback of the copyrighted-material data.

2. The data distribution system according to claim 1, wherein the copyrighted-material data requesting means transmits the permitting condition data to the server when requesting transmission of the copyrighted-material data, and
the copyrighted-material data transmission means appends the permitting condition data received from the communication device to the transmitted copyrighted-material data.

3. The data distribution system according to claim 2, further comprising a reproduction device for receiving the copyrighted-material data transferred from the copyrighted-material data transfer means in anon-line or off-line manner and playing back the copyrighted-material data,
the reproduction device comprising:
playback permission determination means for determining whether or not playback of the copyrighted-material data is permitted based on the permitting condition data appended to the copyrighted-material data; and
copyrighted-material data playback means for playing back the copyrighted-material data if the playback permission determination means determines that playback thereof is permitted,
wherein,
the permitting condition designation means allows the user to designate an individual and/or a reproduction device with respect to whom/which playback permission is requested,
the permitting condition data transmitted from the copyrighted-material data requesting means to the server contains identification data identifying the individual and/or reproduction device designated via the permitting condition designation means, and
the playback permission determination means determines whether or not playback is permitted with respect to the reproduction device and/or the user operating the reproduction device, by referring to the identification data contained in the permitting condition data.

4. The data distribution system according to claim 1, wherein the permitting condition data appended to the copyrighted-material data transmitted from the copyrighted-material data transmission means is preregistered at the server with respect to each of a plurality of users.

5. The data distribution system according to claim 1, further comprising a reproduction device for receiving the copyrighted-material data transferred from the copyrighted-material data transfer means in an on-line or off-line manner and playing back the copyrighted-material data,
the reproduction device comprising:
playback permission determination means for determining whether or not playback of the copyrighted-material data is permitted based on the permitting condition data appended to the copyrighted-material data; and
copyrighted-material data playback means for playing back the copyrighted-material data if the playback permission determination means determines that playback thereof is permitted.

6. The data distribution system according to claim 5, wherein,
the reproduction device further comprises permitting condition deletion means for deleting the permitting condition data appended to the copyrighted-material data received by the reproduction device if the playback permission determination means determines that playback of the copyrighted-material data is not permitted, and
the playback permission determination means determines that that playback of the copyrighted-material data is not permitted if the copyrighted-material data does not have the permitting condition data appended thereto.

7. The data distribution system according to claim 5, wherein,
the copyrighted-material data transmission means further appends, to the copyrighted-material data transmitted to the communication device, an exempting condition based on which to exempt the reproduction device from making a determination as to whether or not to permit playback,
the copyrighted-material data transfer means appends the exempting condition to the copyrighted-material data when transferring the copyrighted-material data to the external device, and
the playback permission determination means determines that playback of the copyrighted-material data is permitted if the exempting condition appended to the copyrighted-material data is satisfied.

8. The data distribution system according to claim 5, wherein,
the communication device is capable of communicating with the reproduction device,
the communication device further comprises reconfirmation requesting means for requesting, when the playback permission determination means determines that playback of the copyrighted-material data is not permitted, the server to again confirm whether or not playback of the copyrighted-material data is permitted with respect to a user attempting to play back the copyrighted-material data, and
the server further comprises:
group member determination means for determining, in response to the request from the communication device, whether the user attempting to play back the copyrighted-material data belongs to a group with respect to which playback of the copyrighted-material data is permitted; and
playback permission notification means for notifying to the communication device, when the group member determination means determines that the user attempting to play back the copyrighted-material data belongs to the group, that playback of the copyrighted-material data is permitted with respect to the user,
the communication device further comprises:
result notification means for notifying the notification from the server to the reproduction device, and
the playback permission determination means again determines whether or not playback of the copyrighted-material data is permitted based on the notification from the communication device.

9. The data distribution system according to claim 5, wherein,
the reproduction device is capable of communicating with the communication device,
the reproduction device further comprises location information detection means for detecting location information,
the communication device further comprises authentication location identifying information transmission means for transmitting, when the playback permission determination means determines that playback of the copyrighted-material data is permitted, authentication location identifying information identifying an authentication location to the server, the authentication location identifying information being based on the location information detected by the location information detection means, and
the server further comprises:
authentication location identifying information reception means for receiving authentication location identifying information from the communication device;
authentication location identifying information storage means for storing the authentication location identifying information received by the authentication location identifying information reception means; and
dishonest authentication determination means for recognizing a hypothetical movement of a user based on the authentication location identifying information already stored in the authentication location identifying information storage means, and detecting, based on the hypothetical movement, an unauthorized attempt to use the copyrighted-material data by a person who is in disguise of an authorized user.

10. The data distribution system according to claim 5, wherein the permitting condition designation means allows the user to designate an individual and/or a reproduction device with respect to whom/which playback permission is requested,
the permitting condition data contains identification data identifying the individual and/or reproduction device designated via the permitting condition designation means, and
the playback permission determination means determines whether or not playback is permitted with respect to the reproduction device and/or the user operating the reproduction device, by referring to the identification data contained in the permitting condition data.

11. The data distribution system according to claim 1, wherein the copyrighted-material data transmission means appends the permitting condition data as an inseparable electronic watermark in the copyrighted-material data.

12. The data distribution system according to claim 1, wherein the copyrighted-material data transmission means appends the permitting condition data to the copyrighted-material data in an inseparable manner.

13. The data distribution system according to claim 12, wherein,
the copyrighted-material data transmission means appends the permitting condition data to the copyrighted-material data in a separable manner, but encrypts the copyrighted-material data together with the appended permitting condition data so that the permitting condition data becomes inseparable from the transmitted copyrighted-material data, and
the copyrighted-material data transfer means transfers the encrypted copyrighted-material data with appended permitting condition data.

14. The data distribution system according to claim 1, further comprising a device on which the copyrighted-material data transferred from the copyrighted-material data transfer means is to be used, wherein the device comprises use permission determination means for determining whether or not playback of the copyrighted-material data is permitted based on the permitting condition data appended to the copyrighted-material data.

15. A server storing copyrighted-material data obtained by encoding a copyrighted material, and distributing the copyrighted-material data to a communication device which is connected to the server over a network in response to a request from the communication device,
the server comprising:
copyrighted-material data acquisition means for acquiring a desired piece of copyrighted-material data in accordance with the request from the communication device; and
copyrighted-material data transmission means for transmitting to the communication device the copyrighted-material data acquired by the copyrighted-material data acquisition means, such that permitting condition data based on which to permit use of the copyrighted-material data is appended to the transmitted copyrighted-material data.

16. The server according to claim 15, wherein the permitting condition data is data which is transmitted from the communication device together with the request to transmit copyrighted-material data.

17. The server according to claim 15, wherein the permitting condition data is preregistered at the server with respect to each of a plurality of users.

18. The server according to claim 15, further comprising playback permission notification means for, in response to a request from the communication device, determining whether or not playback of the copyrighted-material data is permitted with respect to a user attempting to play back the copyrighted-material data, and notifying to the communication device a result of the determination.

19. The server according to claim 18, wherein the playback permission notification means determines that playback of the copyrighted-material data is permitted with respect to the user attempting to play back the copyrighted-material data if the user belongs to a group with respect to which playback of the copyrighted-material data is permitted.

20. The server according to claim 15, wherein the copyrighted-material data transmission means further appends, to the copyrighted-material data transmitted to the communication device, an exempting condition based on which to exempt a reproduction device from making a determination as to whether or not to permit playback of the copyrighted-material data.

21. The server according to claim 15, further comprising:
authentication location identifying information reception means for receiving from the communication device authentication location identifying information which identifies an authentication location of the copyrighted-material data;
authentication location identifying information storage means for storing the authentication location identifying information received by the authentication location identifying information reception means; and
dishonest authentication determination means for recognizing a hypothetical movement of a user based on the authentication location identifying information already stored in the authentication location identifying information storage means, and detecting, based on the hypothetical movement, an unauthorized attempt to use the copyrighted-material data by a person who is in disguise of an authorized user.

22. A communication device being connected via a network to a server storing copyrighted-material data obtained by encoding a copyrighted material, and downloading the copyrighted-material data from the server, comprising:
permitting condition designation means for allowing a user to designate a permitting condition based on which to permit use of the copyrighted-material data;
copyrighted-material data requesting means for notifying to the server the permitting condition designated via the permitting condition designation means, and requesting transmission of a desired piece of copyrighted-material data,
copyrighted-material data reception means for receiving the copyrighted-material data transmitted from the server, with permitting condition data based on the permitting condition notified being appended to the transmitted copyrighted-material data; and
copyrighted-material data transfer means for transferring the copyrighted-material data received by the copyrighted-material data reception means to an external device, with the permitting condition data appended to the transferred copyrighted-material data.

23. The communication device according to claim 22, wherein the permitting condition data is data which is transmitted to the server together with a request to transmit copyrighted-material data.

24. The communication device according to claim 23, wherein
the permitting condition designation means allows the user to designate an individual and/or a reproduction device with respect to whom/which playback permission is requested,
the permitting condition data transmitted from the copyrighted-material data requesting means to the server when making the request to transmit copyrighted-material data contains identification data identifying the individual and/or reproduction device designated via the permitting condition designation means.

25. The communication device according to claim 24, wherein the identification data is biological information identifying the individual.

26. The communication device according to claim 22, wherein the permitting condition data is preregistered at the server with respect to each of a plurality of users.

27. A reproduction device for playing back copyrighted-material data obtained by encoding a copyrighted material,
wherein a permitting condition based on which to permit use of the copyrighted-material data is appended to the copyrighted-material data,
the reproduction device comprising:
playback permission determination means for determining whether or not playback of the copyrighted-material data is permitted based on the permitting condition data appended to the copyrighted-material data; and
copyrighted-material data playback means for playing back the copyrighted-material data if the playback permission determination means determines that playback thereof is permitted.

28. The reproduction device according to claim 27, further comprising individual identification information acquisition means for acquiring identification information concerning a user attempting to play back the copyrighted-material data,
wherein,
the permitting condition data appended to the copyrighted-material data contains identification information concerning an individual with respect to whom playback of the copyrighted-material data is permitted, and
the playback permission determination means determines that playback of the copyrighted-material data is permitted if the identification information acquired by the individual identification information acquisition means matches the identification information contained in the permitting condition data.

29. The reproduction device according to claim 28, wherein,
authentication exempted period information defining an authentication exempted period during which determination as to whether or not to permit playback of the copyrighted-material data is exempted is further appended to the copyrighted-material data, and
during the authentication exempted period, the playback permission determination means omits determination as to whether the identification information acquired by the individual identification information acquisition means matches the identification information contained in the permitting condition data or not.

30. The reproduction device according to claim 29, wherein, if the authentication exempted period is predicted to expire during the playback of the copyrighted-material data, the playback permission determination means presents a warning message prior to the expiration of the authentication exempted period, and determines whether or not playback of the copyrighted-material data is permitted by determining whether the identification information acquired by the individual identification information acquisition means matches the identification information contained in the permitting condition data or not.

31. The reproduction device according to claim 28, wherein,
a plurality of pieces of copyrighted-material data are to be consecutively played back, and
if the authentication exempted period is predicted to expire during the playback of one of the plurality of pieces of copyrighted-material data to be consecutively played back, the playback permission determination means makes a prior determination, with respect to the piece of copyrighted-material data, as to whether the identification information acquired by the individual identification information acquisition means matches the identification information contained in the permitting condition data or not.

32. The reproduction device according to claim 31, wherein, if the authentication exempted period is predicted to expire during the playback of the copyrighted-material data, the playback permission determination means presents a warning message prior to the expiration of the authentication exempted period, and determines whether or not playback of the copyrighted-material data is permitted by determining whether the identification information acquired by the individual identification information acquisition means matches the identification information contained in the permitting condition data or not.

33. The reproduction device according to claim 28, wherein the identification information is biological information concerning an individual with respect whom playback of the copyrighted-material data is permitted, and the individual identification information acquisition means is a biological information detection sensor.

34. The reproduction device according to claim 33, wherein the biological information is fingerprint data of the user, and the biological information detection sensor is a fingerprint sensor.

35. The reproduction device according to claim 27, further comprising device identification information storage means for storing device identification information which is uniquely assigned to the reproduction device,
wherein,
the permitting condition data appended to the copyrighted-material data contains device identification information concerning a reproduction device with respect to which playback of the copyrighted-material data is permitted, and
the playback permission determination means determines that playback of the copyrighted-material data is permitted if the device identification information stored in the device identification information storage means matches the device identification information contained in the permitting condition data.

36. The reproduction device according to claim 27, further comprising:
communication means for communicating with a communication device which is connected via a network to a server storing the copyrighted-material data and downloads the copyrighted-material data from the server; and
reconfirmation requesting means for, if the playback permission determination means determines that playback of the copyrighted-material data is not permitted, requesting the server via the communication means to reconfirm whether or not playback of the copyrighted-material data is permitted with respect to a user attempting to play back the copyrighted-material data,
wherein the playback permission determination means again determines whether or not playback of the copyrighted-material data is permitted based on a result of the reconfirmation which is notified from the server in response to the request from the reconfirmation requesting means.

37. The reproduction device according to claim 27, further comprising:
communication means for communicating with a communication device which is connected via a network to a server storing the copyrighted-material data and downloads the copyrighted-material data from the server;
location information detection means for detecting location information; and
authentication location identifying information transmission means for, when the playback permission determination means determines that playback of the copyrighted-material data is permitted, transmitting authentication location identifying information identifying an authentication location to the server via the communication means, the authentication location identifying information being based on the location information detected by the location information detection means,
wherein the authentication location identifying information is used for detecting an unauthorized attempt at the server to use the copyrighted-material data by a person who is in disguise of an authorized user.

38. The reproduction device according to claim 27, further comprising permitting condition deletion means for deleting the permitting condition data appended to the copyrighted-material data if the playback permission determination means determines that playback of the copyrighted-material data is not permitted,
wherein the playback permission determination means determines that that playback of the copyrighted-material data is not permitted if the copyrighted-material data does not have the permitting condition data appended thereto.

39. An authentication system comprising a server and a communication device which are interconnected over a network for performing an authentication therebetween,
wherein
the communication device comprises:
location information detection means for detecting location information; and
authentication location identifying information transmission means for transmitting, when performing an authentication for the server, authentication location identifying information identifying an authentication location to the server, the authentication location identifying information being based on the location information detected by the location information detection means, and
the server comprises:
authentication location identifying information reception means for receiving authentication location identifying information from the communication device;
authentication location identifying information storage means for storing the authentication location identifying information received by the authentication location identifying information reception means; and
dishonest authentication determination means for recognizing a hypothetical movement of a user based on the authentication location identifying information already stored in the authentication location identifying information storage means, and detecting, based on the hypothetical movement, an unauthorized attempt to use the copyrighted-material data by a person who is in disguise of an authorized user.

40. A method of controlling a system comprising a server storing copyrighted-material data obtained by encoding a copyrighted material, a communication device, and a reproduction device, such that, in response to a request from the communication device, the server distributes the copyrighted-material data to the communication device over a network so as to be played back by the reproduction device, comprising:
a step, performed by the communication device, of allowing a user to designate a permitting condition based on which to permit use of the copyrighted-material data;
a step, performed by the communication device, of notifying the permitting condition to the server, and requesting transmission of a desired piece of copyrighted-material data;
a step, performed by the server of acquiring the desired piece of copyrighted-material data in accordance with the request from the communication device;
a step, performed by the server of transmitting to the communication device the acquired copyrighted-material data, such that permitting condition data based on the permitting condition notified from the communication device is appended to the transmitted copyrighted-material data;
a step, performed by the communication device, of receiving the copyrighted-material data transmitted from the server with the appended permitting condition data;
a step, performed by the communication device, of transferring the received copyrighted-material data to the reproduction device, with the permitting condition data appended to the transferred copyrighted-material data;
a step, performed by the reproduction device, of determining whether or not to permit playback of the copyrighted-material data based on the permitting condition data appended to the copyrighted-material data; and
a step, performed by the reproduction device, of playing back the copyrighted-material data if it is determined that the playback of the copyrighted-material data is permitted.

41. The method according to claim 40, wherein the permitting condition data is data which is transmitted from the communication device together with the request to transmit copyrighted-material data.

42. The method according to claim 40, wherein the permitting condition data is preregistered at the server with respect to each of a plurality of users.
